(19) United States
(12) Patent Application Publication
(10) Pub. No.: US 2005/0270928 A1
(43) Pub. Date: Dec. 8, 2005

(54) Optical disc device

(76) Inventors: Hiroki Sugahara, Kanagawa (JP); Yasushi Okada, Kanagawa (JP); Katsuhiko Okabe, Saitama (JP); Akihiko Okamoto, Kanagawa (JP); Hiroshi Koide, Kanagawa (JP)

Correspondence Address: DICKSTEIN SHAPIRO MORIN & OSHINSKY LLP, 2101 L Street, NW, Washington, DC, 20037, US

(21) Appl. No.: 11/127,105

(22) Filed: May 12, 2005

(30) Foreign Application Priority Data
May 14, 2004 (JP) 2004-145599
Sep. 14, 2004 (JP) 2004-267296
Feb. 10, 2005 (JP) 2005-035034

(51) Int. Cl. G11B 5/09

(52) U.S. Cl. 369/47.1

(57) ABSTRACT

An optical disc device is disclosed. The optical disc device includes a thermal head that is disposed at a side opposite to an optical pickup, which irradiates a laser beam for writing and erasing information, relative to a mounted optical disc, and is configured to bring a thermal head into contact with a label, which is made of a thermosensitive information display film attached on a label-side surface of the mounted optical disc, to write visible information on the label. The optical disc device also includes a low-speed rotation mechanism configured to rotate the optical disc at a low speed by a motor when the thermal head writes visible information on a label, in addition to a high-speed rotation mechanism, such as a spindle motor, configured to rotate the optical disc at high speed when the optical pickup records or reproduces the information.

### BACKGROUND OF THE INVENTION

1. Field of the Invention

The present invention relates to an optical disc device, and more particularly relates to an optical disc device having a function of writing visible information on a thermosensitive information display film attached on a label-side surface of an optical disc.

2. Description of the Related Art

In recent years, various types of disc media for storing digital information magnetically or by forming pits have been widely used. These media are generally called optical discs. The optical discs include discs such as music CDs, CD-ROMs and DVDs on which information is prerecorded, recordable optical discs that can only be written on once, and rewritable optical discs that can be rewritten on a large number of times. These optical discs are becoming increasingly popular.

Optical discs on which information is prerecorded typically have labels on one side (hereinafter referred to as label-side surface) thereof in order to show a content list or to add decorative effects. For example, some music CDs have labels on which CD titles and song titles are printed with specific images, and some CD-ROMs have labels on which a content list is printed with specific images.

On the other hand, recordable optical discs and rewritable optical discs do not have labels on which specific visible information is printed, because users write desired information on the discs later on. Therefore, these types of optical discs often come with cases on which a content list can be written.

It may be convenient if labels such as those attached to music CDs are attached on recordable and rewritable discs so that users can write desired information thereon.

To meet such demands, there are disclosed optical disc devices capable of printing and writing desired information on a label attached on a label-side surface of a rewritable disc in Japanese Patent Laid-Open Publications No. 9-265760 (Reference 1), No. 11-283356 (Reference 2) and No. 2000-173238 (Reference 3).

The optical disc device disclosed in Reference 1 is configured to record information on and reproduce information from an optical disc using an optical head (optical pickup), and has an embedded printing mechanism capable of printing visible information on a label-side surface of the optical disc.

The optical disc device disclosed in Reference 2 is capable of rewriting visible information on a label-side surface of an optical disc as many times as needed. A label used herein is a heat reversible recording medium.

The optical disc device disclosed in Reference 3 is also capable of rewriting visible information on a label-side surface of an optical disc as many times as needed. Specifically, Reference 3 discloses a positioning technique for recording visible information on an appropriate position on a label-side surface.

The optical disc device disclosed in Reference 1 can print visible information on a label surface of an optical disc only once, but it cannot rewrite the information on the label and, therefore, is not suitable for optical discs such as rewritable optical discs that allow recorded information to be optically rewritten. This is because visible information on a label-side surface of this type of rewritable optical disc may need to be rewritten when recorded information is rewritten.

In any of the optical disc devices disclosed in References 1-3, a spindle motor used for rotating an optical disc at a high speed when an optical pickup records or reproduces information by irradiating a laser beam on an optical disc is also used when a print head or a thermal head prints or writes visible information on a label-side surface of the optical disc.

Such a spindle motor is adapted to rotate an optical disc at a high speed appropriate for recording and reproducing information with laser beam irradiation from an optical pickup under servo control. However, it is difficult for the spindle motor to rotate the optical disc at a constant low speed appropriate for writing or printing visible information on a label-side surface of the optical disc under open control.

For this reason, even during operations of printing or writing visible information on the label-side surface of the optical disc, the optical disc is rotated at a relatively high speed. Moreover, the print head or the thermal head, like the optical pickup, is configured to scan spirally on the label-side surface in combination with movements in a radial direction of the optical disc in the operations of printing and writing visible information. This configuration complicates synchronous control and positioning control, prolongs printing and writing time, and lowers the quality of visible information.

### SUMMARY OF THE INVENTION

A general object of the present invention is to provide an optical disc device to solve at least one problem described above. A specific object of the present invention is to provide an optical device capable of finely and quickly writing visible information on a label-side surface of an optical disc with ease. Another specific object of the present invention is to provide a compact optical disc device that offers a function of writing visible information and can be used for both recordable optical discs and rewritable optical discs.

According to an aspect of the present invention, there is provided an optical disc device that comprises a mounting section on which an optical disc serving as an information recording medium is mounted, an optical pickup configured to irradiate a laser beam on the optical disc mounted on the mounting section so as to record and reproduce information, a high-speed rotation mechanism configured to rotate the mounted optical disc at high speed when the optical pickup records or reproduces the information, a thermal head that is disposed at a side opposite to the optical pickup relative to the mounted optical disc, and is configured to bring a heat generating portion into contact with a label, which is made of a thermosensitive information display film attached on a label-side surface of the mounted optical disc, to write visible information on the label, and a low-speed rotation mechanism configured to rotate the mounted optical disc at a speed lower than said high speed when the thermal head writes the visible information on the label.

In an optical disc (rewritable optical disc) on which a label made of a heat reversible information display film is used, a thermal head, configured to bring a heat generating portion into contact with the label attached on a label-side surface of the mounted optical disc to write and erase visible information on the label, is used in place of the above-described thermal head. In this case, when the thermal head writes and erases the visible information on the label, the above-described low-speed rotation mechanism rotates the optical disc at a speed lower than said high speed. With this configuration, visible information on the label can be rewritten every time the optical pickup rewrites information.

Preferably, the thermal head is arranged such that the heat generating portion extends in a radial direction of the mounted optical disc, and is able to be in contact with the label throughout the radius length of a writable area of the label. If the thermal head is arranged so, desired visible information can be written on the entire surface of the label with the thermal head while the low-speed rotation mechanism causes the optical disc to make one rotation or to rotate 360 degrees.

If the thermal head is configured to be constantly turned with a biasing force in a direction where the heat generating portion is brought into contact with the label of the mounted optical disc, the heat generating portion is surely kept in contact with the thermosensitive information display film while the visible information is written.

In that case, it is preferable that the optical disc device further comprise a rod having an eccentric portion, so that a thermal head holder engaged with the eccentric portion of the rod is turned by rotation of the rod to a position where the thermal head is out of contact with the label against the biasing force and to a position where the thermal head is in contact with the label with the biasing force.

If the optical disc device further comprises a supporting member configured to move into contact with an outer circumferential edge of the optical disc to support the optical disc rotatably against a contact force of the thermal head as the thermal head is brought into contact with the label of the optical disc, the optical disc can be surely and stably rotated keeping the same position in a thickness direction.

The low-speed rotation mechanism preferably comprises a roller capable of moving into and out of contact with an outer circumferential edge of the mounted optical disc, and a motor to rotate the roller, wherein when the roller moves into contact with the outer circumferential edge of the optical disc and is rotated, the optical disc is rotated at a low speed by the roller.

The roller preferably has a high friction force at least on the outer circumferential edge thereof. Especially, a rubber roller is preferable.

It is preferable that the optical disc device further comprise an interlocking mechanism to interlock movements of the roller of the low-speed rotation mechanism toward and away from the mounted optical disc and movements of the thermal head toward and away from the label of the optical disc with a drive force of a drive source.

More preferably, the interlocking mechanism is configured to interlock the above-described movements and movements of the supporting member toward and away from the outer circumferential edge of the optical disc.

If the low-speed rotation mechanism, the thermal head, and the interlocking mechanism for these two components are held by a holder, the optical disc device that offers the visible information writing function can be made compact: Likewise, if the low-speed rotation mechanism, the thermal head, the supporting member, and the interlocking mechanism for these three components are held by a holder, the optical disc device can be made compact.

The above-described low-speed rotation mechanism may comprise a pair of rollers or pulleys around which a belt is extended to allow the belt to move into and out of contact with an outer circumferential edge of the mounted optical disc, and a motor to rotate the belt, wherein when the belt moves into contact with the outer circumferential edge of the optical disc and is rotated, the optical disc is rotated at a low speed by the belt.

Alternatively, the above-described low-speed rotation mechanism may comprise a low-speed rotation motor, and a transmission section to transmit a drive force of the motor to the mounted optical disc so as to rotate the optical disc at a low speed, wherein the transmission section serves as a supporting member that supports the optical disc rotatably against a contact force of the thermal head.

In that case, the transmission section may comprise a stepped roller having a large diameter portion and a small diameter portion formed integrally on the large diameter portion, wherein the stepped roller is driven by the low-speed rotation motor, an outer circumferential edge of the small diameter portion moves into contact with the outer circumferential edge of the optical disc to rotate the optical disc at a low speed, and an upper face of the large diameter portion supports a face of the optical disc opposite to a face with which the thermal head moves into contact.

Alternatively, the transmission section may comprise a stepped roller having a large diameter portion and a small diameter portion formed integrally on the large diameter portion, and a belt extending around an outer circumferential edge of the small diameter portion of the stepped roller and a second roller or a pulley, wherein the stepped roller is driven by the low-speed rotation motor, the belt moves into contact with the outer circumferential edge of the optical disc to rotate the optical disc at a low speed, and an upper face of the large diameter portion of the stepped roller supports a face of the optical disc opposite to a face with which the thermal head moves into contact.

The second roller or the pulley may include a stepped roller having a large diameter portion and a small diameter portion formed integrally on the large diameter portion such that a part of the belt extending between the small diameter portions of the two stepped rollers moves into contact with the outer circumferential edge of the optical disc to rotate the optical disc at a low speed, and an upper face of the large diameter portion of each of the stepped rollers supports a face of the optical disc opposite to a face with which the thermal head moves into contact.

It is preferable that the upper face of the large diameter portion of each of the stepped rollers have an upwardly bulging annular surface, so that a contact area between the stepped rollers and the optical disc is reduced.

It is preferable to use a rubber belt or a timing belt (including a rubber timing belt) as the above-described belt to prevent slippage.

A ball-shaped rolling support may be used in place of the supporting member to support a face of the mounted optical disc opposite to a face with which the thermal head moves into contact. The ball-shaped rolling support may be disposed at a position opposing the thermal head through the optical disc.

Alternatively, at least two of the ball-shaped rolling supports may be disposed at opposite sides of a position of the thermal head in a radial direction of the optical disc within an angular spacing of 180 degrees or less at a side opposing the thermal head through the optical disc. The angular spacing may be set to 90 degrees or less for improving the supporting function.

The at least two of the ball-shaped rolling supports are preferably disposed at positions symmetrical relative to the position of the thermal head in the radial direction of the optical disc.

It is preferable that the high-speed rotation mechanism include a high-speed rotation motor configured to be rotated by rotation of the optical disc when the high-speed rotation motor is not driven, and a rotation signal generating section to generate signals corresponding to a rotation speed of the high-speed rotation motor; the low-speed rotation mechanism include a low-speed rotation motor; and a disc rotation control section be provided that controls rotation of the low-speed rotation motor according to the signals generated by the rotation signal generating section so as to rotate the optical disc at a predetermined speed, when the low-speed rotation motor is driven to cause the low-speed rotation mechanism to rotate the mounted optical disc at a low speed and the high-speed rotation motor is rotated by rotation of the optical disc.

The rotation signal generating section may generate FG signals corresponding to a rotation speed of the high-speed rotation motor, and the disc rotation control section may be configured to control the rotation of the low-speed rotation motor according to the FG signals.

If the thermal head comprises plural thermal heads arranged along a radial direction of the mounted optical disc, visible information can be surely written and erased even when the optical disc has warpage in the radial direction thereof.

It is preferable that the heat generating portions of the thermal heads overlap in the radial direction of the optical disc in a connected part where the thermal heads abut each other.

According to the optical disc device of the present invention, when visible information is written on the label attached to the label-side surface of the optical disc with the thermal head, the optical disc can be rotated at a constant low speed appropriate for recording. Therefore, the visible information can be finely and surely written on the label.

In the case where the thermal head is arranged such that the heat generating portion extends in the radial direction of the mounted optical disc and is able to be in contact with the label throughout a radial length of the writable area of the label, while the above-described low-speed rotation mechanism causes the optical disc to make one rotation, desired visible information can be written on the label, or existing visible information can all be erased from the label by the thermal head. Also, while the above-described low-speed rotation mechanism causes the optical disc to make another rotation, new visible information can be written.

If the low-speed rotation mechanism comprises the roller capable of moving into and out of contact with the outer circumferential edge of the mounted optical disc, and the motor to rotate the roller, and if the interlocking mechanism is provided to interlock movements of the roller of the low-speed rotation mechanism toward and away from the mounted optical disc and movements of the thermal head toward and away from the label of the optical disc with a drive force of a drive source (and movements of the supporting member toward and away from the outer circumferential edge of the optical disc) with the drive force of a single drive source, the visible information writing function is switched on and off by simple operations.

If the low-speed rotation mechanism, the thermal head, the supporting member, and the interlocking mechanism are held by the single holder, the optical disc device that offers the visible information writing function can be made compact.

In the case where there are components for controlling the low-speed rotation mechanism and the low-speed rotation motor, and components for supporting the optical disc, when visible information is written on the label attached to the label-side surface of the optical disc with the thermal head, the optical disc can be surely supported and rotated at a constant low speed appropriate for recording and surely supported with the thermal head being in tight contact with the label. Therefore, the visible information can be finely and surely written on the label.

### BRIEF DESCRIPTION OF THE DRAWINGS

FIG. 1 is a perspective view schematically showing main parts of an optical disc device of a basic embodiment of the present invention together with an optical disc;

FIG. 2 is a side view schematically showing a spindle motor and an optical pickup of the optical disc device;

FIG. 3 is a side view showing a different example of a rubber roller used in a low-speed rotation mechanism together with an outer circumferential edge of an optical disc;

FIG. 4 is an exploded perspective view showing a configuration example of the optical disc used in the optical disc device of the present invention;

FIG. 5 is a plan view showing an example of a label on which visible information is written;

FIG. 6 is a graph showing a relationship between temperature change and transparency for explaining recording principle of a TC film employed as the label;

FIG. 7 is a block diagram showing an embodiment of the optical disc of the present invention including a control system thereof;

FIG. 8 is a perspective view schematically showing a mechanism section of an optical disc device to which the present intention is applied;

FIG. 9 is a schematic cross-sectional view of the mechanism section;

FIG. 10 is a plan view of the mechanism section in an unloading state;

FIG. 11 is a plan view showing a configuration example of a visible information writing unit installed in the optical disc device of FIGS. 8-10;

FIG. 12 is an exploded perspective view showing an interlocking mechanism for a low-speed rotation mechanism and disc supporting claws together with the optical disc;

FIG. 13 is an exploded perspective view showing a thermal head supporting mechanism and the interlocking mechanism;

FIG. 14 is an enlarged cross-sectional view showing main parts of a thermal head supporting section together with the optical disc and a spindle motor, etc.;

FIG. 15 is a plan view showing main parts of an embodiment of a low-speed rotation mechanism using a belt;

FIG. 16 is a cross-sectional view showing main parts of a first embodiment wherein a part of a low-speed rotation mechanism serves as a disc supporting member;

FIG. 17 is a cross-sectional view showing main parts of a second embodiment wherein a part of a low-speed rotation mechanism serves as a disc supporting member;

FIG. 18 is a plan view of FIG. 17;

FIG. 19 is a cross-sectional view showing a different example of a stepped roller;

FIG. 20 is a cross-sectional view showing a different embodiment of a disc supporting member;

FIG. 21 is a plan view showing a positional relationship between a ball bearing and a thermal head;

FIG. 22 is a block diagram showing an embodiment wherein a disc rotation control section for low-speed rotation is provided;

FIG. 23 is a schematic side view for explaining a problem due to warpage of the optical disc in a radial direction in the case where one thermal head is provided;

FIG. 24 is a schematic side view showing an example of a thermal head divided into two parts in a longitudinal direction thereof;

FIG. 25 is a top view of an optical disc of FIG. 24;

FIG. 26 is a schematic side view showing another example of a thermal head divided into two parts in a longitudinal direction thereof;

FIG. 27 is an exploded perspective view showing a thermal head unit;

FIG. 28 is an illustration of the thermal head in contact with an optical disc seen from the center side of the optical disc;

FIG. 29 is a plan view showing main parts of another embodiment of a low-speed rotation mechanism in an optical disc device of the present invention during a visible information recording operation; and

FIG. 30 is a plan view showing main parts of the low-speed rotation mechanism during a data recording operation.

### DETAILED DESCRIPTION OF THE PREFERRED EMBODIMENT

Exemplary embodiments of the present invention are described hereinafter with reference to the accompanying drawings.

### Basic Embodiment

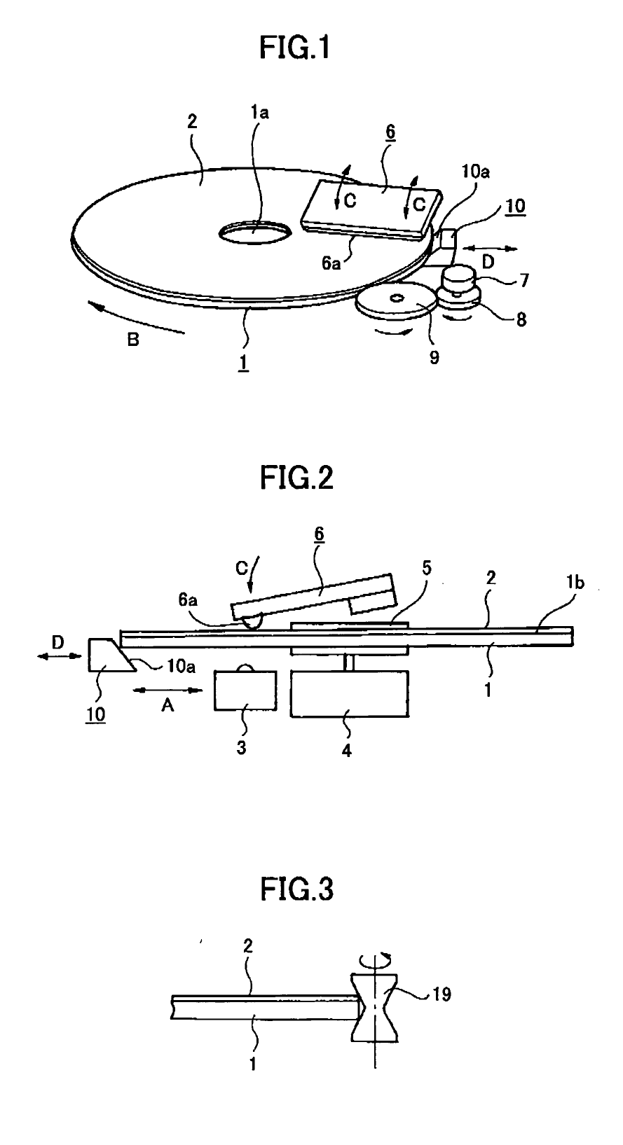

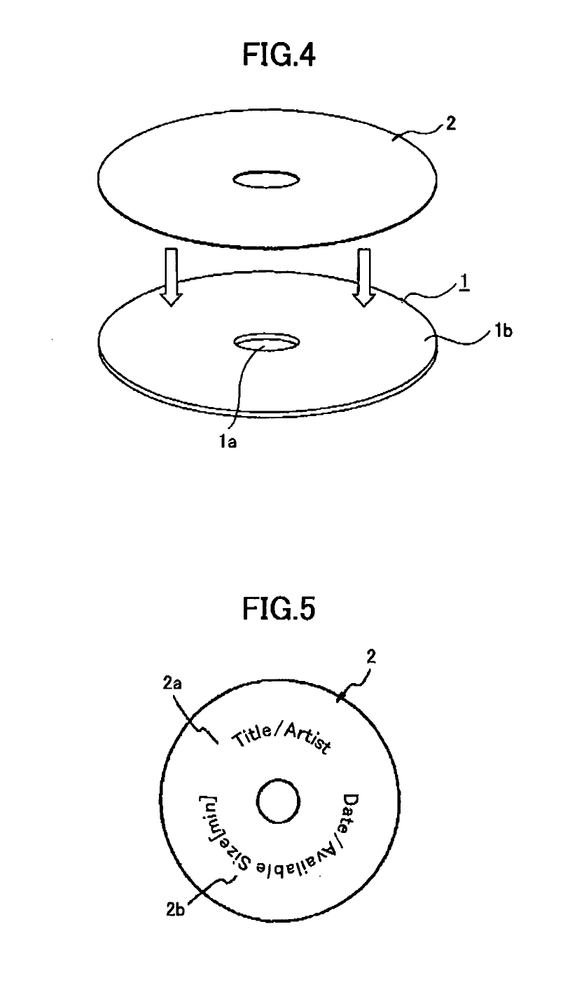

FIG. 1 is a perspective view schematically showing main parts of an optical disc device of a basic embodiment of the present invention together with an optical disc. FIG. 2 is a side view schematically showing a spindle motor and an optical pickup in addition to the components shown in FIG. 1. FIG. 3 is a side view showing a different example of a rubber roller. FIG. 4 is an exploded perspective view showing a configuration example of the optical disc.

In FIGS. 1-4, an optical disc is denoted by a reference number 1. As shown in FIG. 4 in detail, the optical disc 1 is formed in a disk shape having a center opening 1a. A doughnut-shaped label 2, on which visible information is written, is attached on a label-side surface 1b opposite to an optical recording surface. The optical disc 1 may include recordable optical discs (CD-R, DVD-R, DVD+R, etc.) that can only be written on once, and rewritable optical discs (CD-RW, DVD-RAM, DVD-RW, DVD+RW, etc.) that can be rewritten on repeatedly. The label 2 may include a thermosensitive information display sheet, which is described below in more detail. The label 2 may be a type that can only be written on once, if applied to a recordable optical disc. However, it is preferable that the label 2 be a type that can be rewritten on as many times as needed such as a heat reversible information display sheet.

Referring back to FIG. 2, like common optical disc devices, the optical disc device of this embodiment is provided with a high-speed rotation mechanism comprising an optical pickup 3 that irradiates a laser beam on the optical disc 1 placed on a tray (not shown) and mounted in a mounting section to reproduce or record information, a spindle motor 4 that rotates the optical disc 1 at high speed (1000-10000 rpm) when the optical pickup 3 reproduces or records information on the optical disc 1, and a spindle 5. The optical pickup 3 is moved in directions (radial direction of the optical disc 1) indicated by an arrow A by a scanning mechanism (not shown).

Further, there are provided components that serve to implement the present invention, which are a thermal head 6 that writes visible information on a label 2 attached to a label-side surface of the optical disc 1 by bringing a heat generating portion 6a into contact with the label 2, and a low-speed rotation mechanism that rotates the optical disc 1 at a speed much lower than the high rotation speed of the spindle motor 4.

As shown in FIG. 1, the low-speed rotation mechanism of this embodiment comprises a low-speed rotation motor 7 such as a stepping motor, a friction roller 8 fixed to a rotating shaft of the motor 7, and a rubber roller 9 rotated by the friction roller 8. The low-speed rotation mechanism rotates the optical disc 1 in the direction indicated by an arrow B at a low liner velocity of around 10 mm/sec (at the outer circumferential edge) by bringing the rubber roller 9 into contact with the outer circumferential edge of the optical disc 1. While the roller 9 is a rubber roller in this embodiment, a roller made of other materials may alternatively be employed as long as the roller has a high friction coefficient at, at least, an outer circumferential edge thereof to be in contact with the optical disc 1 and can rotate the optical disc 1 stably. For example, a resin roller having a rough outer circumferential edge may be employed as the roller 9.

The thermal head 6 is arranged such that the heat generating portion 6a extends in the radial direction of the optical disc 1 and can be in contact with the label 2 throughout a length of a radius of a writable area of the label 2. For instance, the thermal head 6 has a recordable width of 35 mm and can write or erase visible information on the entire surface of the doughnut-shaped label 2 while the optical disc 1 makes only one rotation, i.e., rotates 360 degrees.

The thermal head 6 is turnably supported in the directions of arrows C (FIG. 1) by a shaft (not shown) extending in the radial direction of the optical disc 1 and is biased downward by a spring. The thermal head 6 causes the heat generating portion 6a to be pressed on and in contact with a surface of the label 2 of the optical disc 1 at approximately 9 degrees at the time of writing or erasing visible information.

In this embodiment, a disc supporting claw 10 is provided that comes into contact with an outer edge of the optical disc 1 as the thermal head 6 comes into contact with the loaded optical disc 1. The disc supporting claw 10 supports the optical disc 1 in sliding contact against a contact force of the thermal head 6. The disc supporting claw 10 is a trapezoidal block and is movable between a position where a slant face 10a thereof is in contact with the outer edge of the optical disc 1 and a position retracted therefrom in directions indicated by an arrow D. The optical disc 1 can be securely supported by the spindle 5 and the disc supporting claw 10 when the optical disc 1 is rotated by the rubber roller 9 at a low speed. The optical disc 1 can be supported more stably if there are provided plural of the disc supporting claws 10 along the periphery of the optical disc 1.

The disc supporting claw 10 does not have to be provided and may be omitted. For example, if an hourglass-shaped or concave roller 19 shown in FIG. 3 made of rubber or other materials is used in place of the rubber roller 9 constituting the low-speed rotation mechanism shown in FIG. 1, the roller 19 can serve as the rubber roller 9 for rotating the optical disc 1 at a low-speed and as the disc supporting claw 10 for supporting the optical disc 1. That is, the roller 19 can rotate the optical disc 1 and keep the position of the optical disc 1 in the thickness direction of the optical disc 1 by a V-shaped side face.

In this embodiment, when the optical pickup 3 writes desired information such as music, images, documents, and programs on the optical recording surface of the optical disc 1, visible information related to the information written on the optical recording surface, such as titles and contents, can be written on the label 2 by the thermal head 6.

FIG. 5 is an example of the label 2 on which information 2a including a title and the artist name and information 2b including a date and available size (remaining recordable time) are written. Visible information may be added to a blank space of the label 2a whenever information is added to the optical recording surface of the optical disc 1. Alternatively, the existing visible information such as the title and the artist name may all be erased and replaced by new visible information.

For example, if all the information recorded on a rewritable optical disc is erased and replaced by new information, all the existing visible information on the label 2 may also be erased and replaced by new visible information.

In this embodiment, when the thermal head 6 writes visible information on the label 2 attached to the label-side surface of the optical disc 1, the optical disc 1 is rotated at a constant low-rotation speed appropriate for recording by the low-speed rotation mechanism including the motor 7 and the rubber roller 9. Therefore, the visible information can be finely and surely written on the label 2.

In this embodiment, the thermal head 6 is arranged such that the heat generating portion 6a extends in the radial direction of the optical disc 1 and can be in contact with the label 2 throughout the radial length of the writable area of the label 2, and the recordable width of the thermal head 6 is 35 mm, which is the same as the radial length of the writable area of the label 2. Therefore, while the above-described low-speed rotation mechanism causes the optical disc 1 to make one rotation, desired visible information can be written on the label 2, or existing visible information can all be erased from the label 2 by the thermal head 6. Also, while the above-described low-speed rotation mechanism causes the optical disc 1 to make another rotation, new visible information can be written.

The following describes the label 2 attached to the label-side surface 1b of the optical disc 1 in detail with specific examples. There have been developed various materials applicable to thermosensitive information display films (thermosensitive recording media) such as heat-reversible information display films (heat reversible recording media) that can be used as the label 2. The materials are transparent or colored at ambient temperature but lose transparency or change colors reversibly when heated.

For instance, Japanese Patent Laid-Open Publication No. 61-258853 discloses a material containing two or more types of polymers being blended. The material becomes transparent or whitish depending on the solubility of the polymers. Japanese Laid-Open Publication No. 62-66990 discloses a material applying the phase changes of a liquid crystal polymer. Japanese Laid-Open Publication No. 55-154198 discloses a material containing heat reversible resin such as vinyl chloride resin in which long-chain low molecules are dispersed. The material becomes transparent at a first predetermined temperature and becomes whitish at a second predetermined temperature. Further, Japanese Laid-Open Publication No. 2-188293 discloses a material containing a leuco dye and a long-chain alkyl developer. The material develops colors such as black, red, and blue after being heated at a predetermined second temperature and loses colors at a first predetermined temperature.

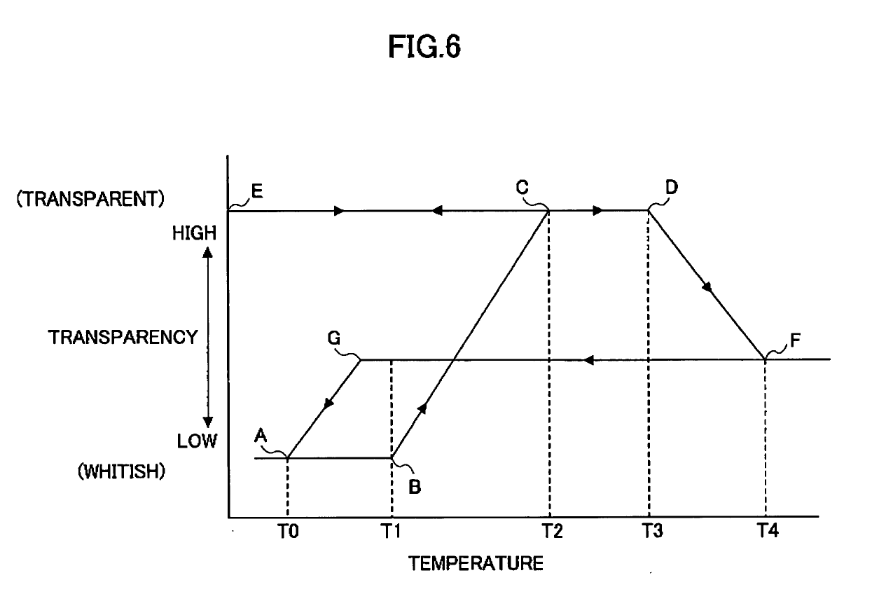

In this embodiment, a TC film (Thermo-Chromic film) made of a heat reversible material is employed as the label 2. The recording principle of the TC film is explained with reference to FIG. 6. In FIG. 6, the vertical axis represents the transparency level of the TC film, and the horizontal axis represents the heating temperature.

When the TC film is heated to a temperature T0 (A), to T1 (B), to T2 (C), and to T3 (D), the transparency is increased to a point E. After that, when the temperature returns to T2 (C), to T1 (B), and to T0(A), the transparency is kept at the point E.

On the other hand, when the TC film is heated to a temperature T0 (A), to T1 (B), to T2 (C), to T3 (D), and to T4 (F), the transparency is increased once and then decreased to a semitransparent state. After that, when the temperature is lowered, the transparency keeps at the same level without being increased. When the temperature falls below the ambient temperature, the transparency level falls below a point G to be a whitish state. In this case, the temperature T3 is a first temperature for making the TC film transparent to erase visible information, and the temperature T4 is a second temperature for selectively making the TC film whitish to record visible information.

This phenomenon occurs due to the following fact. When a resin base material contained in the TC film and particles of organic low-molecular substances dispersed in the resin base material are kept in tight contact with each other and the particles of the organic low-molecular substances do not have voids thereinside, a light beam incident from one side passes through to the other side without being diffused. Therefore, the film looks transparent. On the other hand, when fine crystals of the particles of the organic low-molecular substances come together to form polycrystals, clearances are formed at interfaces between the polycristals or interfaces between the particles and the resin base material. Therefore, the light beam incident from one side is reflected and refracted by the interfaces between the clearances and the crystals and interfaces between the crystals and resin and, therefore, is diffused. This makes the film look whitish.

The label 2 is not limited to the TC film that changes between the transparent state and the whitish state depending on the heating temperature and keeps the changed state even after the temperature returns to the ambient temperature, but may include other various heat reversible display films that change between two or more color tones depending on the heating temperature and keep the changed state even after the temperature returns to the ambient temperature.

If the label 2 is applied to recordable optical discs, a thermosensitive display film like thermosensitive recording paper that can only be written on once by the thermal head may be employed as the label 2.

### Explanation for Block Diagram of Embodiment

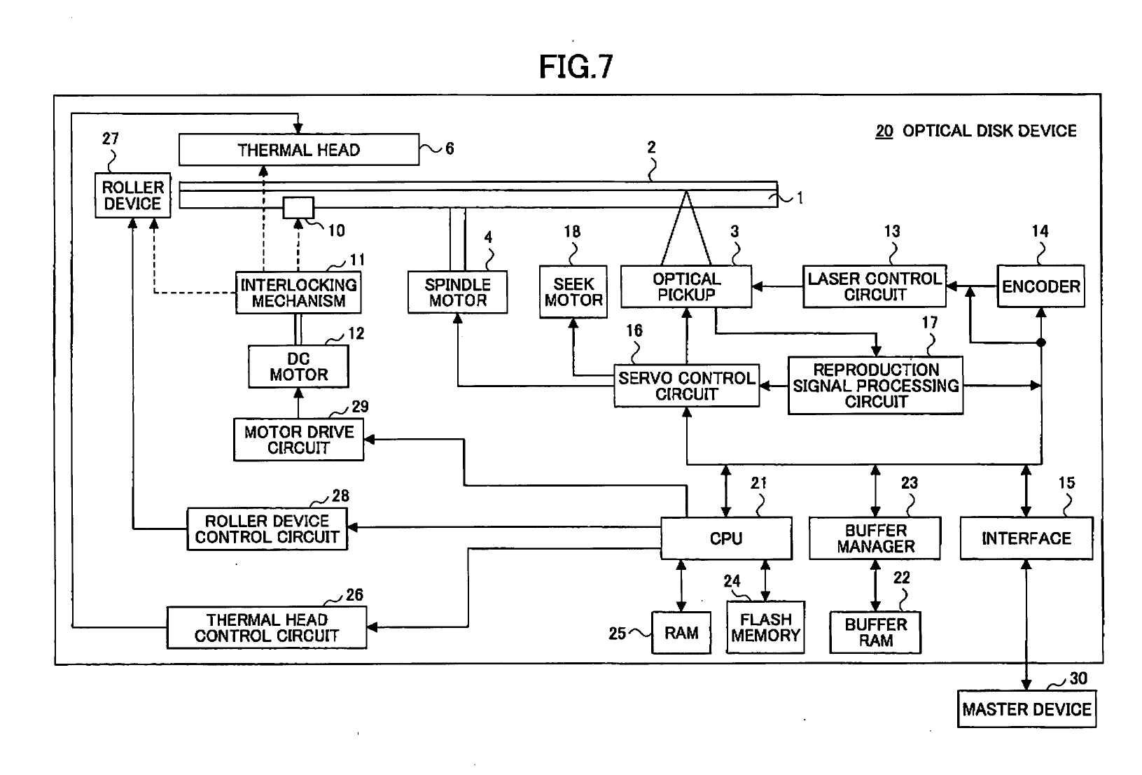

The following describes a configuration of an embodiment of an optical disc device 20 of the present invention including a control system illustrated in FIG. 7. In FIG. 7, components corresponding to those shown in FIGS. 1-4 bear the same reference numbers.

The optical disc device 20 shown in FIG. 7 comprises a spindle motor 4 for rotating an optical disc 1, an optical pickup 3 for irradiating a laser beam on the optical disc 1 to record information thereon, and a seek motor 18 for driving the optical pickup 3 in a sledge direction. The optical disc device 20 further comprises a laser control circuit 13 for controlling a laser beam irradiated from the optical pickup 3, and an encoder 14 for encoding data provided from a master device 30 such as a personal computer through an interface 15 into a format appropriate for recording on the optical disc 1.

The optical disc device 20 also includes a servo control circuit 16 for controlling the spindle motor 4, the seek motor 18, and an objective lens drive mechanism installed on the optical pickup 3, and a reproduction signal processing circuit 17 for processing data read by the optical pickup 3 and decoding the data such that the master device 30 can read the data as well as generating servo signals to be output to the servo control circuit 16.

The optical disc device 20 further includes a buffer RAM 22 for temporally holding data read from the optical disc 1, data to be optically recorded on the optical disc 1, and data for writing visible information on the label 2, a buffer manager 23 for controlling data input to and output from the buffer RAM 22, the interface 15 for two-way communications with the master device 30, a CPU 21 for controlling the entire operation of the optical disc device 20, a flash memory 24 for storing programs executed by the CPU 21, and a RAM 25 for temporarily holding data used by the CPU 21 for controlling the optical disc device 20.

The components described above are the same as those in usual optical disc devices. In addition to these components, the optical disc device 20 includes unique components, which are a thermal head 6 for displaying visible information by applying heat to the TC film label 2 attached to the optical disc 1, a thermal head control circuit 26 for controlling heat generation and drive of the thermal head 6, a roller device 27 constituting a low-speed rotation mechanism for rotating the optical disc 1 while the thermal head 6 is operated, and a roller device control circuit 28 for controlling driving of the roller device 27. The roller device 27 corresponds to the low-speed rotation mechanism in the embodiment shown in FIG. 1 comprising the motor 7, the friction roller 8, and the rubber roller 9.

The optical disc device 20 also includes a disc supporting claw 10 that comes into sliding contact with the outer edge of the optical disc 1 for supporting the optical disc 1 while the optical disc 1 is rotated at a low speed, an interlocking mechanism 11 for moving the disc supporting claw 10 to be in contact or out of contact with the optical disc 1 in conjunction with the movements of the thermal head 6 of coming into contact or out of contact with the outer circumferential edge of the optical disc 1 and the movements of the rubber roller of the roller device 27 coming into or out of contact with the outer circumferential edge of the optical disc 1, a DC motor 12 for driving the interlocking mechanism, and a motor drive circuit 29. The interlocking mechanism is described below in more detail with specific examples.

In FIG. 7, arrows with solid lines indicate typical flow of signals and information, but do not show all the connections among the components. Arrows with dashed lines indicate mechanical interlock relation of the interlocking mechanism 11. A double line between the interlocking mechanism 11 and the DC motor 12 indicate a power transmission relation.

The optical pickup 3 is configured to irradiate a laser beam on a recording surface of the optical disc 1 having a spiral track and receive light reflected by the recording surface. The optical pickup 3 comprises an optical system, which includes a semiconductor laser serving as a light source and an objective lens, for guiding a light beam irradiated from the semiconductor laser to the recording surface of the optical disc 1 and guiding a returning light beam reflected by the recording surface to a predetermined light receiving position, an optical receiver disposed on the light receiving position for receiving the returning light beam, and a drive system (a focusing actuator and a tracking actuator). The optical receiver outputs signals corresponding to the amount of the received light to the reproduction signal processing circuit 17.

The reproduction signal processing circuit 17 comprises an I/V amplifier, a servo signal detecting circuit, a wobble signal detecting circuit, an RF signal detecting circuit, and a decoder. The I/V amplifier converts current signals output from the optical receiver of the optical pickup 3 into voltage signals and amplifies the signals at a predetermined gain. The servo signal detecting circuit detects servo signals such as focus error signals and track error signals based on the signals output from the I/V amplifier. The detected servo signals are output to the servo control circuit 16. The wobble detecting circuit detects wobble signals based on the signals output from the I/V amplifier.

The RF signal detecting circuit detects RF signals based on the signals output from the I/V amplifier. The decoder extracts address information and synchronizing signals from the wobble signals. The extracted address information is output to the CPU 21, while the extracted synchronizing signals are output to the encoder 14. The decoder decodes the RF signals and detects errors. If an error is detected, the decoder corrects the error and stores the corrected decoded signals as reproduction data into the buffer RAM 22 through the buffer manager 23.

The servo control circuit 16 comprises an optical pickup control circuit, a seek motor control circuit, and a spindle motor control circuit. The optical pickup control circuit generates drive signals for the focusing actuator based on the focus error signals in order to correct focus misalignment of the objective lens of the optical pickup 3. The optical pickup control circuit also generates drive signals for the tracking actuator based on the track error signals in order to correct track misalignment of the objective lens, The generated drive signals are output to the optical pickup 3. Tracking control and focus control are performed based on these signals.

The seek motor control circuit generates drive signals for driving the seek motor 18 according to instructions from the CPU 21. The generated drive signals are output to the seek motor 18. The spindle motor control circuit generates drive signals for driving the spindle motor 4 according to instructions from the CPU 21. The generated drive signals are output to the spindle motor 4.

The buffer RAM temporally holds data (recording data) to be recorded on the optical disc 1, data (reproduction data) reproduced from the optical disc 1, and data sent from the master device 30 to be written on the label 2 for displaying visible information. Data input to and data output from the buffer RAM 22 are controlled by the buffer manager 23.

The encoder 14 retrieves the recording data accumulated in the buffer RAM 22 through the buffer manager 23 according to instructions from the CPU 21, and modulates the data and adds error correction codes to generate write signals for the optical disc 1. The generated write signals are output to the laser control circuit 13.

The laser control circuit 13 controls the power of the laser beam irradiated from the semiconductor laser of the optical pickup 3. For example, the laser control circuit 13 generates drive signals for the semiconductor laser based on the write signals, recording conditions, and light emitting properties of the semiconductor laser.

The interface 15 serves as a two-way communication interface with the master device 30, and complies with standard interfaces such as ATAPI (AT Attachment Packet Interface), SCSI (Small Computer System Interface), and USB (Universal Serial Bus).

The flash memory 24 includes a program area and a data area. The program area of the flash memory 24 stores programs written in codes that the CPU 21 can read. The data area of the flash memory 24 stores the recording conditions, the light emitting properties of the semiconductor laser, and heat generation conditions of the thermal head 6.

The CPU 21 controls operations of the above-described components according to the programs stored in the program area of the flash memory 24, and loads data necessary for the control into the RAM 25 and the buffer RAM 22.

The roller device control circuit 28 controls the rotation speed of the stepping motor that rotates the rubber roller of the roller device 27 according to instructions from the CPU 21.

The thermal head 6 has a heat generating portion including plural heating elements arranged in a row for writing information on the TC film of the label 2 with heat, and also has a thermal head drive mechanism for causing the thermal head to come into or out of contact with the label 2 on the optical disc 1.

The thermal head control circuit 26 drives the thermal head 6 according to instructions from the CPU 21, and causes the heating elements of the thermal head 6 to generate heat based on data for displaying information, which are sent from the master device 30 and held in the buffer RAM 22.

### Explanation for Mechanism of Specific Embodiments

The following describes specific embodiments of the optical disc device of the present invention in detail.

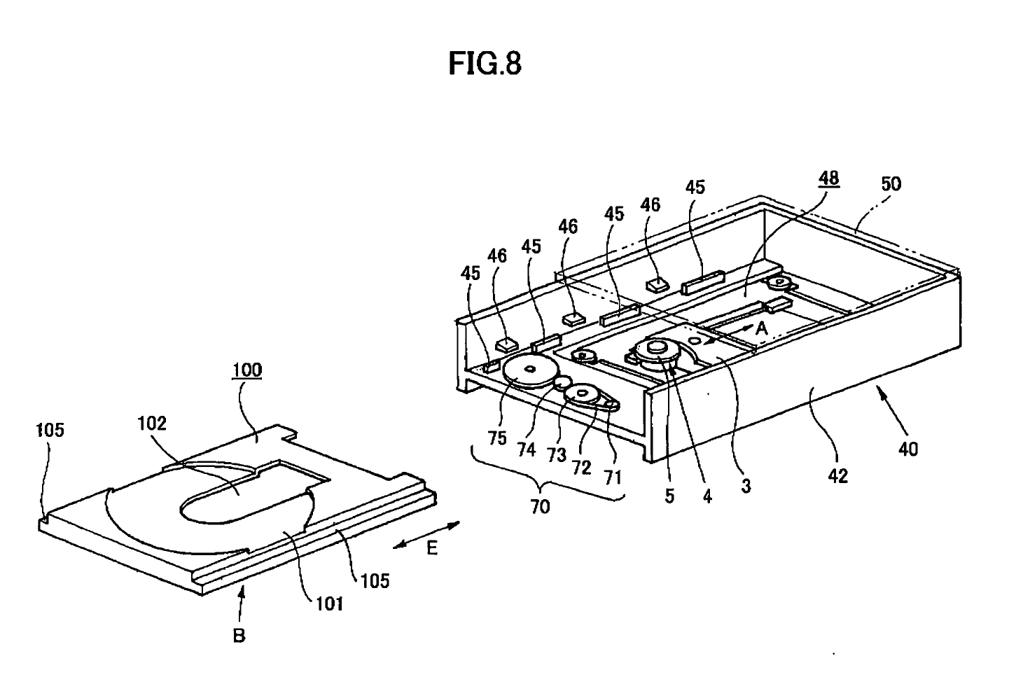

First, a mechanism section of an optical disc device according to the present invention that is the same as those in usual optical disc devices is described with reference to FIGS. 8-10.

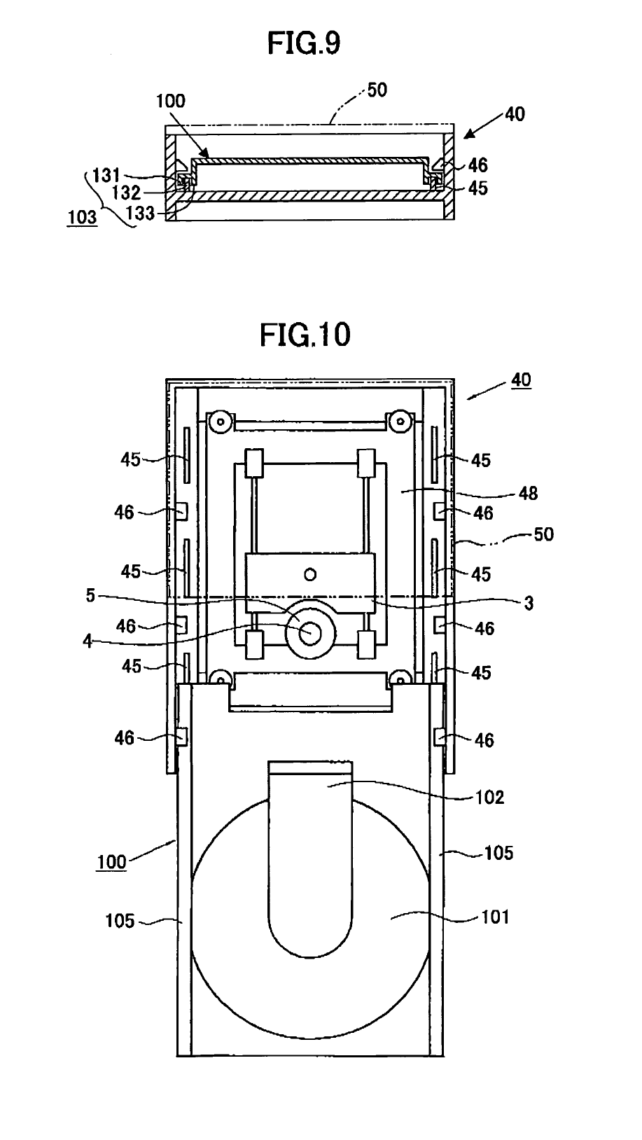

FIG. 8 is a perspective view schematically showing the mechanism section of the optical disc device. FIG. 9 is a schematic cross-sectional view of the mechanism section. FIG. 10 is a plan view of the mechanism section in an unloading state. It is noted that FIGS. 8-10 do not show the mechanisms unique to this invention, which are mounted in a visible information writing unit holder 50 indicated by chain double-dashed lines to form a visible information writing unit. Mechanism sections indicated by solid lines are the same as those in usual optical disc devices.

The mechanism sections of this optical disc device comprise a loading base 40 and a tray 100.

The loading base 40, as shown in FIGS. 8 and 10, comprises a loading mechanism 70 including a loading motor 71, a belt 72, a pulley gear 73, a middle gear 74, and a gear 75 at the open front side of the bottom section of a rectangular frame 42. The loading base 40 also includes a traverse mechanism 48 including a spindle motor 4 on which a spindle 5 is mounted, and an optical pickup 3 at the center of the bottom section. The loading base 40 further comprises plural projecting rails 45 parallel in the longitudinal direction on both sides of the bottom section in the longitudinal direction of the loading base 40, and plural protruding tray retainer 46 on the inner surface of both side walls.

The tray 100 comprises a circular recessed section 101 at the center on which the optical disc is placed, and an opening 102 having a semicircular front part and a rectangular rear part. The tray 100 also includes a stepped section 105 on each side thereof in the longitudinal direction.

The tray 100 is slidably attached to the generally box-shaped loading base 40 having an opening end such that a part of the tray is pulled out from and into the opening of the frame 42.

Referring to FIG. 9, the tray 100 has rail grooves 103 on both sides of a lower surface thereof in the longitudinal direction (corresponding positions of the stepped sections 105 at the opposite side). Each of the rail groove 103 includes an outer projection 131, a groove section 132, and an inner projection 133 in parallel in the longitudinal direction. The rail grooves 103 slidably fit on the corresponding rails 45 of the loading base 40.

The inner projection 133 of one of the rail grooves 103 has a sawtooth rack (not shown) facing the inner side of the tray 100 to mesh with the gear 75 of the loading mechanism 70.

In loading and unloading operations in the optical disc, the loading motor 71 is rotated, and the rotation is transmitted to the rack of the tray 100 through the belt 72, the pulley gear 73, the middle gear 74, and the gear 75. Thus the tray 100 is slidably moved in directions indicated by an arrow E (FIG. 8)

More specifically, in the loading operation, the tray 100 in an unloading state shown in FIG. 10 is pulled into the loading base 40, and the traverse mechanism 48 is lifted to a position of a clamper (not shown) attached to the upper side of the loading base 40. Then the spindle 5 is inserted in the center opening 1a of an optical disc 1 such as the optical disc 1 shown in FIG. 1, so the optical disc is rotatably held by the clamper and the spindle 5.

In this state, i.e, the state where the optical disc is mounted on the mounting section, the spindle motor 4 rotates the optical disc at high speed by the spindle motor while the optical pickup 3 scans in the directions of the arrow A and irradiates a laser beam so as to record information on the optical disc or read information recorded on the optical disc.

On the other hand, in the unloading operation, the traverse mechanism 48 is lowered to a position shown in FIG. 8, and the tray 100 is ejected to the outside of the loading base 40 to allow the optical disc placed on the recessed section 101 to be removed.

The tray retainers 46 inhibit the tray 100 from being lifted from the bottom section of the loading base 40 over a predetermined distance so as to prevent the tray 100 from coming off from the loading base 40.

The plate-like holder 50 holding the components of the visible information writing unit unique to this invention is fixed to the upper side of the frame 42 of the loading base 40 such that components of the visible information writing unit are arranged in a space at the upper side of the traverse mechanism 48.

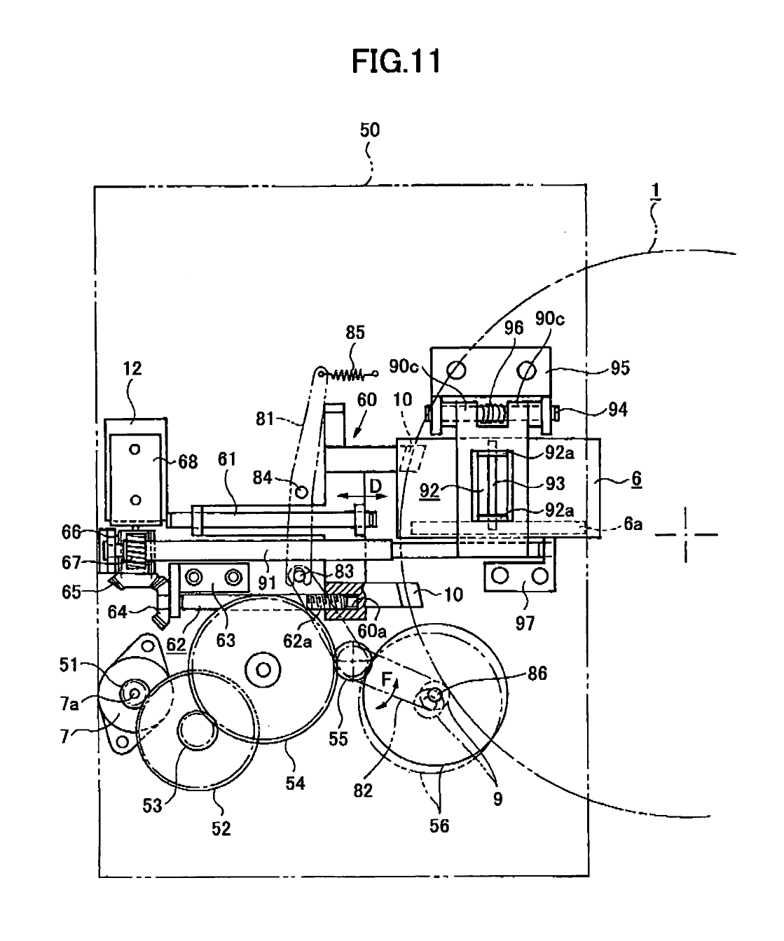

A configuration example of the visible information writing unit installed in the optical disc device of this embodiment is illustrated in FIGS. 11-14.

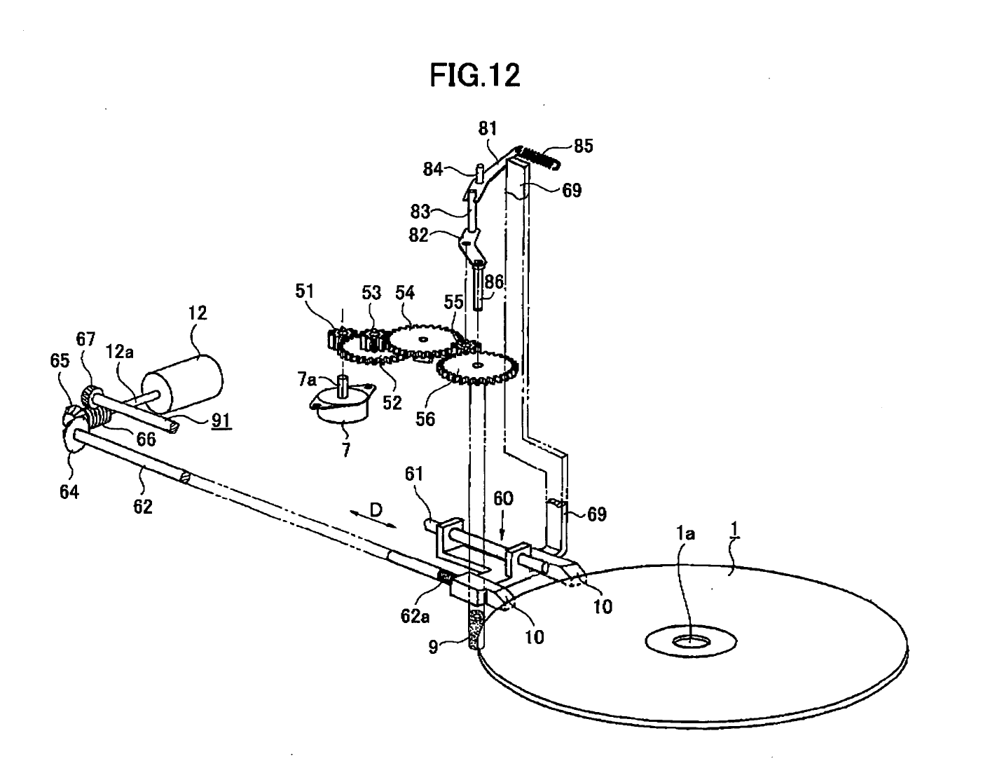

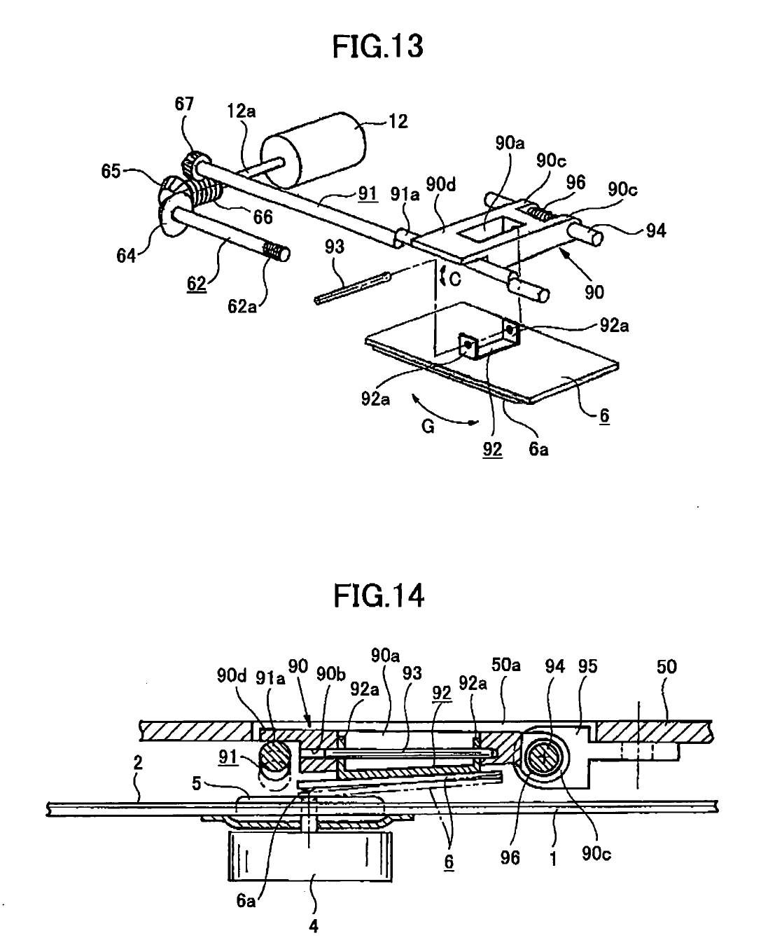

FIG. 11 is a plan view showing the visible information writing unit. FIG. 12 is an exploded perspective view showing a low-speed rotation mechanism and an interlocking mechanism supporting claws together with the optical disc. FIG. 13 is an exploded perspective view showing a thermal head supporting section and interlocking mechanism. FIG. 14 is an enlarged cross-sectional view showing main parts of the thermal head supporting section together with the optical disc and the spindle motor, etc. In FIGS. 11-14, components corresponding to those shown in FIGS. 1-10 bear the same reference numbers, although some of the components have different shapes. The thermal head supporting section, the spindle motor, and the spindle are located in the same position in FIG. 14 for the purpose of explanation, although they are not actually located in the same position.

The following describes the low-speed rotation mechanism, the disc supporting claw, and the interlocking mechanism for them with reference to FIGS. 11 and 12.

The low-speed rotation mechanism (corresponding to the roller device 27 in FIG. 7) for rotating an optical disc 1 at a low speed during operations of writing or erasing visible information comprises a low-speed rotation motor 7 such as a stepping motor, a speed reduction wheel array including a pinion gear 51 fixed to a rotating shaft 7a of the motor 7, a spur gear 52 that meshes with the pinion gear 51, a pinion gear 53 coaxial with the spur gear 52 to mesh with the pinion gear, a spur gear 54 that meshes with the pinion gear 53, a pinion gear 55 that meshes with the spur gear 54, a spur gear 56 that meshes with the pinion gear 55, and a rubber roller 9 coaxial with the spur gear 56. The material of the roller 9 is not limited to rubber, and other materials may be applicable.

When the motor 7 is driven and the rotating shaft 7a is rotated, the rubber roller 9 is rotated at a speed lowered by the speed reduction wheel array. When the rubber roller 9 is in contact with the outer circumferential edge of the optical disc 1 mounted on the mounting section as shown in FIG. 12, the optical disc 1 is rotated at a low liner velocity of around 10 mm/sec (at the outer circumferential edge).

In this example, a claw block 60 is provided integrally with two disc supporting claws 10 spaced apart in the circumferential direction of the optical disc 1. The claw block 60 is supported by a guide shaft 61 extending in the radial direction of the optical disc 1 so as to be slidable in the directions (the radial direction of the optical disc 1) of an arrow D (FIG. 12). The guide shaft 61 is attached to the visible information writing unit holder 50 indicated by the chain double-dashed line in FIG. 11 by an attaching member (not shown).

Referring to FIG. 11, a receiving screw hole 60a is formed on an end of the claw block 60. A projecting screw portion 62a formed on the front end of a rod 62 is threaded into the receiving screw hole 60a. The rod 62 is rotatably supported by a bracket 63 attached to the visible information writing unit holder 50. A bevel gear 64 is attached to an end of the rod 62 at the opposite side of the projecting screw portion 62a.

The bevel gear 64 meshes with a bevel gear 65 attached to a front end of a rotating shaft 12a of a DC motor 12. When the DC motor 12 is driven to rotate the rotating shaft 12a, the rod 62 is rotated thorough the bevel gears 65 and 64. The length of the projecting screw portion 62a threaded in the receiving screw hole 60a of the claw block 60 is thus changed, so the claw block 60 is moved in the directions of the arrow D due to such screw feeding function. Thus, the disc supporting claws 10 are moved to positions to be in contact with the outer circumferential edge of the optical disc 1 and a position retracted therefrom by rotating and counter rotating the DC motor 12.

A worm gear 66 is also attached to the rotating gear 12a of the DC motor 12, and the worm gear 66 meshes with a worm wheel 67. The worm wheel 67 is attached to an end of a rod 91 extending parallel to the rod 62. Therefore, when the rotating shaft 12a of the DC motor 12 is rotated, the rod 91 is also rotated through the worm gear 66 and the worm wheel 67. The functions of the rod 91 are described below with reference to FIG. 13.

In FIG. 11, an element denoted by the reference number 68 is a bracket used for mounting the DC motor 12 on the visible information writing unit holder 50. An element denoted by a reference number 97 is a bracket used for supporting the other end of the rod 91 onto the visible information writing unit holder 50.

As shown in FIG. 12, an upwardly extending interlocking piece 69 is provided on an end of the claw block 60 at the opposite side of the receiving screw hole 60a.

An arm of a first lever 81 and an arm of a second lever B2 are engaged with each other through a pin 83. A middle portion of the first lever 81 is supported by a shaft 84 to be turnable relative to the visible information writing unit holder 50. The first lever 81 is turnably biased by a coil spring 85 attached between an end of the first lever 81 and the visible information writing unit holder 50 such that the other arm is in contact with the interlocking piece 69.

A middle portion of the second lever 82 is coaxial with the pinion gear 55 of the speed reduction wheel array and is turnably supported by the visible information writing unit holder 50. A shaft 86 disposed at an end opposite to the pin 83 rotatably supports the spur gear 56 integrally provided with the rubber roller 9. The spur gear 56 holds a shaft of the pinion gear 55 to be rotatable about a shaft of the pinion gear 55 in directions indicated by an arrow F in FIG. 11.

With this configuration, when the claw block 60 is located at a retracted position with the disc supporting claws 10 retracted from the outer edge of the optical disc 1, the interlocking piece 69 turns the first lever 81 counterclockwise in FIGS. 11 and 12 against the biasing force of the coil spring 85. The second lever 82 is therefore turned clockwise, so the spur gear 56 and the rubber roller 9 are moved to the positions indicated by the chain double-dashed lines in FIG. 11 by the shaft 86. Therefore, the rubber roller 9 is retracted away from the outer circumferential edge of the optical disc 1.

In this state, when the rod 62 is rotated by the DC motor 12 and the claw block 60 is moved forward, the disc supporting claws 10 are also moved forward to be in contact with the outer lower edge of the optical disc 1 and thus slidably support the optical disc 1. Meanwhile, the interlocking piece 69 is also moved in a direction that allows the first lever 81 to turn rightward. Thus, the first lever 81 is turned rightward in FIGS. 11 and 12 by the biasing force of the coil spring, and the second lever 82 is turned leftward through the pin 83. Thus, the spur gear 56 and the rubber roller 9 are moved in the positions indicated by the solid lines and the dashed lines in FIG. 11. The rubber roller 9 thus contacts the outer circumferential edge of the optical disc 1. When the rubber roller 9 is rotated by the torque of the motor 7, the optical disc 1 is rotated at a low speed.

In this way, the disc supporting claws 10 and the rubber roller 9 of the low speed rotation mechanism are moved between the positions to be in contact with the optical disc 1 and the positions retracted therefrom in conjunction with each other.

Next, a thermal head supporting mechanism and the interlocking mechanism are described mainly referring to FIGS. 13 and 14.

A reference number 90 in FIGS. 13 and 14 indicates a block shaped thermal head holder having a relatively large window hole 90a. Both side upright portions 92a of a bracket 92 fixed to a back surface of the tabular thermal head 6 are fitted into the window hole 90a. Then, a shaft 93 is pushed into shaft holes 90b to support the bracket 92. The thermal head 6 is thus supported to be slightly turnable in the directions of an arrow G relative to a direction in which the linear heat generating portion 6a extends.

The thermal head holder 90 has two bearing portions 90c projecting from corresponding sides of a rear end of the thermal head holder 90. A supporting shaft 94 is inserted into the bearing portions 90c so that the bearing portions 90c can be turned relative to the supporting shaft 94. The supporting shaft 94 is supported and fixed by a bracket 95 shown in FIGS. 11 and 14. The bracket 95 is attached to the visible information writing unit holder 50 by screws (not shown) or the like. The thermal head holder 90 is arranged such that a part thereof is inserted in an opening section 50a of the visible information writing unit holder 50. Thus, the thermal head holder 90 is supported to be turnable in the directions of an arrow C in FIG. 13 about the supporting shaft 94 parallel to a direction in which the heat generating portion 6a of the thermal head 6 extends. Each of the ends of a coil spring 96 in which the supporting shaft 94 is inserted are engaged with the supporting shaft 94 and the corresponding bearing portion 90c, so the thermal head holder 90 is constantly biased to be turned counterclockwise in FIG. 14. The thermal head 6 supported by the thermal head holder 90 is therefore biased to be turned in the same manner.

FIG. 13 also shows the mechanism section that rotates the rods 62 and 91 by the DC motor 12. The rod 91 moves the thermal head 6 to a retracted position indicated by a solid line in FIG. 14 and to an operational position indicated by a chain double-dashed line. The rod 91 is turnably supported on the visible information writing unit holder 50 through a bracket (not shown). An eccentric portion 91a is provided at the middle part of the rod 91. An engagement piece 90d extending along the front end edge of the thermal head holder 90 is placed on the eccentric portion 91a.

In a rotated state where the eccentric portion 91a of the rod 91 is positioned at the upper side as shown in FIG. 13, the engagement piece 90d of thermal head holder 90 is pushed upward against the biasing force of the coil spring 96, so the thermal head holder 90 is located at a lifted position shown in FIG. 14. The thermal head 6 is also located at a lifted position indicated by a solid line in FIG. 14, so the heat generating portion 6a is located at a retracted position spaced apart from the label 2 on the optical disc 1.

In a rotated state where the rod 91 is rotated 180 degrees from the above-described state and the eccentric portion 91a of the rod 91 is positioned at the lower side, the thermal head holder 90 is moved so that the engagement piece 90d of thermal head holder 90 is lowered by the biasing force of the coil spring 96. When the heat generating portion 6a of the thermal head 6 contacts the label 2 on the optical disc 1 as shown by chain double-dashed line in FIG. 14, the rotation is stopped and the engagement piece 90d is slightly spaced apart from the eccentric portion 91a of the rod 91 to the upper side. At this position, which is the operational position of the thermal head 6, the thermal head 6 can erase the visible information written on the label 2 by heating the heat generating portion 6a to the first predetermined temperature and write visible information on the label 2 by heating the heat generating portion 6a to the second predetermined temperature.

At this time, since the thermal head 6 is turnalble in both the directions of the arrow C and the arrow G in FIG. 13 and is biased in the direction in which the heat generating portion 6a is pushed on the label 2, the thermal head 6 can keep the whole area of the heat generating portion Ga in contact with the label 2 even if the optical disc 1 is slightly inclined or warped or even if the condition changes depending on the rotation position relative to the thermal head 6.

Therefore, the visible information can be surely erased or written on the entire surface of the label 2.

Mechanisms operated in conjunction with each other by the rods 62 and 91 and the interlocking piece 69 with the torque of the above-described DC motor 12 form an interlocking mechanism that interlocks the movements of the rubber roller 9 of the low-speed rotation mechanism to be in contact or out of contact with the outer circumferential edge of the optical disc 1, the movements of the heat generating portion 6a of the thermal head 6 to be in contact or out of contact with the label 2 on the optical disc 1, and the movements of the disc supporting claws 10 to be in contact or out of contact with the outer circumferential edge of the optical disc 1 with a drive force of a single drive source (DC motor 12).

All of these mechanisms are attached to and held by the visible information writing unit holder 50 indicated by the chain double-dashed line in FIG. 11 to form the visible information writing unit.

The disc supporting claws 10 serving as supporting members may be omitted, the interlocking mechanism interlocks only the movements of the rubber roller 9 of the low-speed rotation mechanism to be in contact or out of contact with the outer circumferential edge of the optical disc 1, and the movements of the heat generating portion 6a of the thermal head 6 to be in contact or out of contact with the label 2 on the optical disc 1.

In such a case, disc supporting claws and interlocking section of the interlocking mechanism for the disc supporting claws are omitted from the visible information writing unit.

[Various Modifications]

The following describes various embodiments of the optical disc device of the present invention which are partly modified from the above-described embodiments. Configurations or components identical to those described in the above embodiments are not further described.

(1) Modified Embodiment of Low-Speed Rotation Mechanism

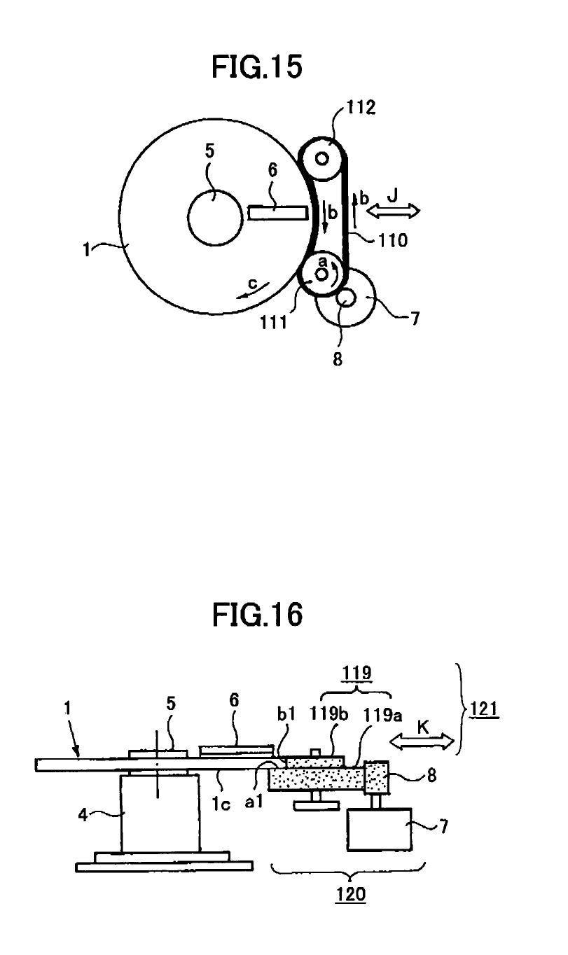

FIG. 15 is a plan view schematically showing a modified low-speed rotation mechanism. This low-speed rotation mechanism comprises a pair of pulleys 111 and 112 with an endless belt 110 extending therearound such that the endless belt 110 is moved to be in contact or out of with the outer circumferential edge of the optical disc 1, and a motor 7 such as a stepping motor for rotating the belt 110. Referring to FIG. 15, the motor 7 makes a friction roller 8 attached to a rotating shaft to be in contact with the belt 110 on the pulley 111 so as to directly rotate the belt 110. It should be appreciated that the belt 110 may be rotated through the pulley 111. In such a case, various types of rotation transmission mechanisms such as rollers, wheels, and belts may be provided between the motor 7 and the pulley 111.

The pair of the pulleys 111 and 112 and the belt 110 extending therearound are attached so as to be movable together in the directions (radial direction of the optical disc 1) of an arrow J. The interlocking mechanism brings the belt 110 into contact with the outer circumferential edge of the optical disc 1 as a thermal head (not shown) is moved to be in contact with the label-side surface of the optical disc 1, and brings the belt 110 out of contact with the outer circumferential edge of the optical disc 1 as the thermal head is retracted from the label-side surface of the optical disc 1. The motor 7 and the rotation transmission mechanism thereof may be moved together in the directions of the arrow J. Alternatively, the motor 7 and most of the parts of the rotation transmission mechanism may be configured to stay in the same position.

With reference to FIG. 15, when the pulley 111 is rotated in the directions of an arrow a with the belt 110 being in contact with the outer circumferential edge of the optical disc 1, the belt 110 is rotated in the directions of an arrow b and the optical disc 1 is rotated in the directions of an arrow c at a low speed. This low-speed rotation mechanism can more surely rotate the optical disc 1 at a constant low speed.

It is preferable that a timing belt having a high friction force or having teeth on the inner surface be used as the belt 110 in order to prevent slippage. It is most preferable to use a rubber timing belt. In the case where a timing belt is used, timing pulleys having teeth on the outer circumferential edge on which the timing belt is disposed are used as the pulleys 111 and 112. In the case where a rubber belt is used, a pair of rollers may be employed in place of the pulleys 111 and 112.

Since the thickness of a typical optical disc is only 1.6 mm, slippage might occur when the optical disc is rotated only by a friction roller in contact with the outer circumferential edge of the optical disc. Such concerns of slippage are eliminated when the optical disc is rotated by a belt in contact along the outer circumferential edge of the optical disc as described above.

(2) First Embodiment Wherein a Part of Low-Speed Rotation Mechanism Serves as Disc Supporting Member

The following describes an embodiment wherein a low-speed rotation mechanism includes a low-speed rotation motor and a transmission section, which transmits the drive force of the motor to a mounted optical disc to rotate the optical disc at a low speed and also serves as a supporting member for supporting the optical disc against the contact force of a thermal head with reference to FIG. 16.

The low-speed rotation mechanism 120 shown in FIG. 16 includes a low-speed rotation motor 7 and a transmission section 121 that transmits the drive force of the motor 7 to the optical disc 1 mounted on the spindle 5 to rotate the optical disc 1 at a low speed. A stepped roller 119 of the transmission section 121 serves as a supporting member for supporting the optical disc 1 against the contact force of a thermal head 6.

The transmission section 121 of the low-speed rotation mechanism 120 comprises the stepped roller 119 having a large diameter portion 119a and a small diameter portion 119b integrally formed on the large diameter portion 119a. The stepped roller 119 is rotated in contact with a friction roller 8 mounted on a rotating shaft of the low-speed rotation motor 7, so an outer circumferential edge b1 of the small diameter portion 119b contacts the outer circumferential edge of the optical disc 1 to rotate the optical disc 1 at a low speed. An upper face a1 of the large diameter portion 119a slidably supports a face 1c of the optical disc 1 opposite to the face in contact with the thermal head 6.

When the optical disc 1 is rotated at a low speed in this way, a high-speed rotation spindle motor 4 is not driven, and a rotating shaft thereof is rotated in conjunction with the low-speed rotation of the optical disc 1. Although the motor 7 of the low-speed rotation mechanism 120 is configured to rotate the stepped roller 119 through the friction roller 8 that is attached to the rotating shaft of the motor 7 and is in contact with the large diameter portion 119a in FIG. 16, various types of rotation transmission mechanisms such as rollers, wheels, and belts may be provided between the friction roller 8 and the stepped roller 119 of the transmission section 121.

Although the entire part of the stepped roller 119 may be made of a material having a high friction coefficient such as rubber, it is preferable that at least the outer circumferential edge b1 of the small diameter portion 119b be made of a material having a high friction coefficient such as rubber and the large diameter portion 119a be made of a material having a relatively small friction coefficient such as metal and plastic.

The stepped roller 119 of the low-speed rotation mechanism 120 is attached to be movable in a direction of an arrow K to a position where the outer circumferential edge b1 of the small diameter portion 119b and the upper face a1 of the large diameter portion 119a are in contact with the optical disc 1 as shown in FIG. 16 and to a position where they are completely separated from the optical disc 1.

(2) Second Embodiment Wherein a Part of Low-Speed Rotation Mechanism Serves as Disc Supporting Member

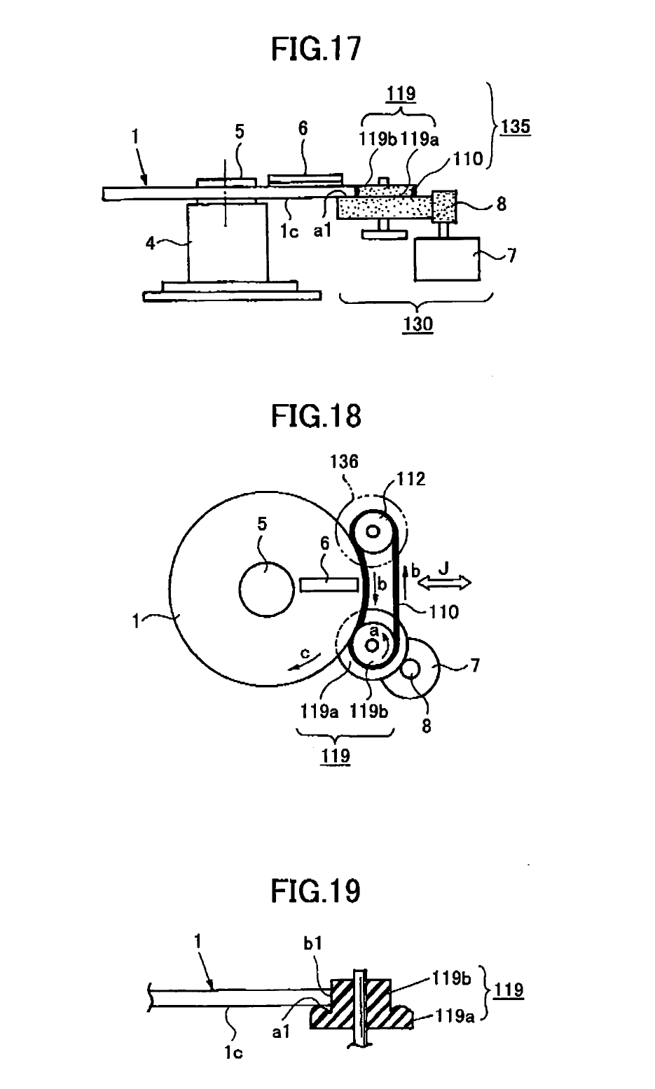

An embodiment shown in FIGS. 17 and 18 is a combination of the embodiment shown in FIG. 15 and the embodiment shown in FIG. 16. In FIGS. 17 and 18, components corresponding to those in FIGS. 15 and 16 bear the same reference numbers.

In a transmission section 130 of a low-speed rotation mechanism 130 in this embodiment, a stepped roller 119 is used in place of the pulley 111 shown in FIG. 15, and a belt 110 is extended around an outer circumferential edge of a small diameter portion 119b and a pulley (or a roller) 112 arranged apart therefrom along an outer circumferential edge of the optical disc 1.

The stepped roller 119 and the belt 110 are driven by a low-speed rotation motor 7, so the belt 110 contacts the outer circumferential edge of the optical disc 1 to rotate the optical disc 1 at a low speed. An upper face a1 of a large diameter portion 119a of the stepped roller 119 rotatably supports the face 1c of the optical disc 1 opposite to the face in contact with the thermal head 6. Although the upper face a1 of the large diameter portion 119a contacts the face 1c, i.e., an optical information recording surface of the optical disc 1, the upper face a1 of the large diameter portion 119a only contacts a part of the area at the part of the face 1c where information is not recorded. Therefore, an optical information recording section is not damaged.

It is preferable that a stepped roller 136 indicated by a chain double-dashed line in FIG. 18 be used in place of the pulley 112 of this embodiment so that an upper face of the large diameter portion of the stepped roller 136 also rotatably supports the face of the optical disc 1 opposite to the face in contact with the thermal head 6. In this case, the belt 110 is extended around a small diameter portion of the stepped roller 136 and the small diameter portion 119b of the stepped roller 119. The stepped rollers 119 and 136 are preferably symmetrically disposed perpendicular to the radial direction of the optical disc 1 relative to the position of the thermal head 6 disposed along the radial direction of the optical disc 1.

It is also preferable that the upper face a1 of the stepped roller 119 in these embodiments have an upwardly bulging annular surface as shown in FIG. 19 to have a smaller contact area with the face 1c of the optical disc 1 and, therefore, to have a smaller friction resistance. If the stepped roller 136 (if provided) indicated by the chain double-dashed line shown in FIG. 18 is provided, the upper face of the stepped roller 136 preferably has an upwardly bulging annular surface.

As in the embodiment illustrated in FIG. 15, it is preferable to use a rubber belt or a timing belt (including a rubber timing belt) as the belt 110 in order to prevent slippage.

(3) Modified Disc Supporting Member

The following describes an embodiment wherein a modified disc supporting member for supporting a face of a mounted optical disc opposite to a face in contact with a thermal head is used.

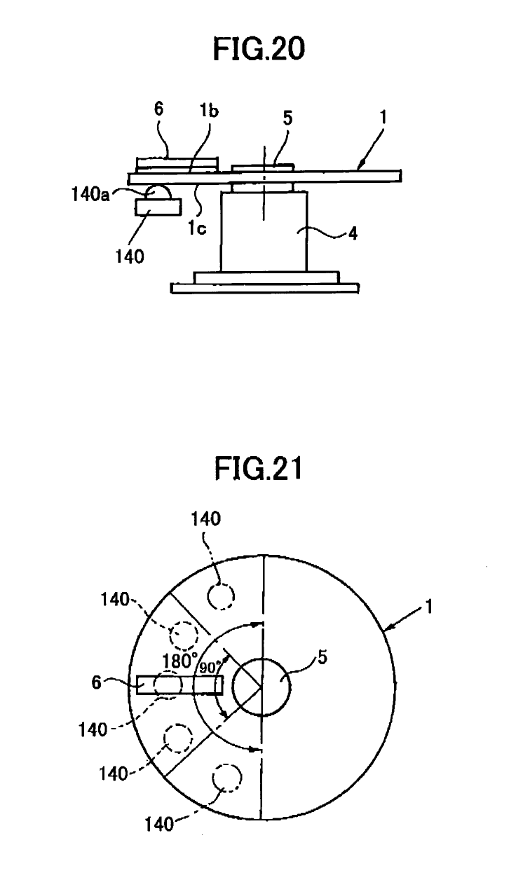

Referring to FIG. 20, a ball bearing 140 serving as a ball-shaped rolling support body serving as an optical disc supporting member is disposed to face the thermal head 6 through an optical disc 1 mounted on a spindle. A transmission section of a low-speed rotation mechanism (not shown) used in this embodiment does not have to serve as a disc supporting member. When the optical disc 1 is rotated at a low speed and a thermal head 6 contacts a label-side surface 1b to write visible information thereon, the lower face 1c of the optical disc 1 is rotatably supported by a top part of a ball 140a of the ball bearing 140. Since the ball 140a of the ball bearing 140 makes only a point contact with the lower face ic of the optical disc 1 and the ball 140a is rotatable in all directions, friction loss is very small.

If one ball bearing (ball-shaped rolling support) 140 is provided, the ball bearing 140 is preferably arranged on a position facing the thermal head 6 through the optical disc 1 as shown in FIG. 20.

If one or more pairs of the ball bearings (ball-shaped rolling supports) 140 are provided, the ball bearings 140 are arranged on both sides of the position of the thermal head 6 in the radial direction of the optical disc 1 within an angular spacing of 180 degrees or less as shown in FIG. 21. Preferably, the ball bearings 140 are arranged to be symmetric with respect to the position of the thermal head 6. It is more preferable that the angular spacing be 90 degrees or less.

It is further preferable that one ball bearing 140 be arranged on a position facing the thermal head 6 through the optical disc 1, and one or more pairs of the ball bearings 140 be arranged on both sides of the position of the thermal head 6 in the radial direction of the optical disc 1. The ball-shaped rolling support is not limited to the ball bearing 140 but may be other types of ball-shaped rotatable supporting member.

(4) Embodiment Wherein Disc Rotation Control Section is Provided

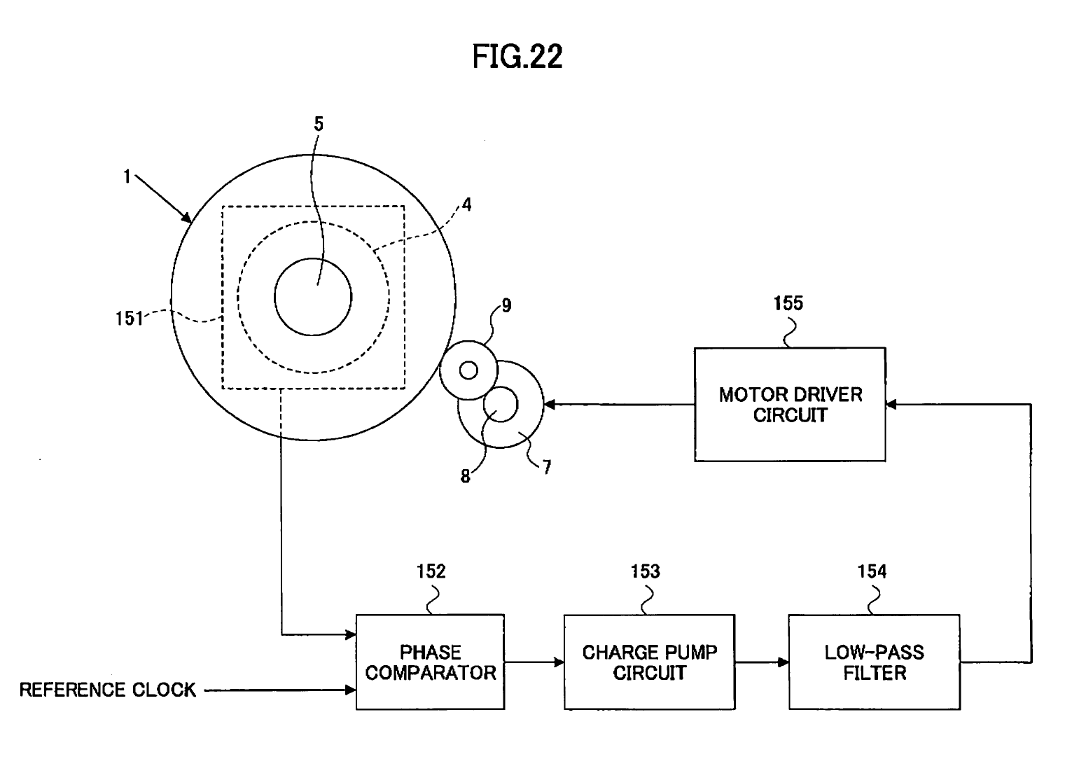

The following describes an embodiment wherein a disc rotation control section is provided with reference to FIG. 22. In FIG. 22, components corresponding to those in the above-described embodiments bear the same reference numbers.

Referring to FIG. 22, there are shown a motor driver circuit 151 for driving a spindle motor 4, a phase comparator 152, a charge pump circuit 153, a low-pass filter 154, and a motor driver circuit 155 for driving a low-speed rotation motor 7.

The motor 7 in this embodiment rotates a rubber roller 9 in contact with an outer circumferential edge of an optical disc 1 in order to correspondingly rotate the optical disc 1 as in the embodiments shown in FIGS. 1, 2, 11 and 12. If slippage occurs between the optical disc 1 and the rubber roller 9, the motor 7 might not be able to rotate the optical disc 1 at a constant speed during operations of writing or erasing visible information on the optical disc 1. This embodiment solves such problem with electric power.

A high-speed rotation spindle motor 4 typically uses a brushless motor and is provided with plural Hall elements (e.g. three Hall elements for three-phase coil). The motor driver circuit 151 properly selects the plural coils according to the output from the Hall elements and properly supplies electric currents to each coil. Therefore, the spindle motor 4 can be rotated without a brush.

In this embodiment, the Hall elements and the motor driver circuit 151 are utilized as a rotation signal generating section, so the rotation of the motor 7 is controlled with use of output from one of the Hall elements when the motor 7 rotates the optical disc 1 at a low speed during the operations of writing visible information on a label-side surface of the optical disc 1.

When the optical disc 1 is rotated at a low speed, the motor driver circuit 151 does not provide a driving current to the coils, and therefore the spindle motor 4 is not driven. When the optical disc 1 is rotated by the motor 7 at a low speed, a rotating shaft of the spindle motor 4 is correspondingly rotated through a spindle 5. Then, the Hall element outputs pulse signals corresponding to the rotation speed. The signals are sent from the motor driver circuit 151 to the phase comparator 152. The phase comparator 152 compares the phase of the signals with a reference clock and detects the phase difference. The reference clock has the same clock frequency same as the frequency of the pulse signals output from the Hall element of the motor driver circuit 151 at the time when the rotation speed of the optical disc 1 becomes a predetermined rotation speed.

A phase difference signal detected by the phase comparator 152 is converted into a voltage at a rate proportional to the phase difference by the charge pump circuit 153 Then, a voltage signal passes through a low-pass filter (also called a loop filter) 154, which smoothens the voltage signal by blocking high-frequency components for stabilizing the control system. The output from the low-pass filter 154 is input to the motor driver circuit 155 to control the rotation speed of the motor 7. That is, if the phase of the pulse signals from the motor driver circuit 151 is shorter than the reference clock, the rotation speed of the motor 7 is reduced based on the phase difference. If, on the other hand, the phase of the pulse signals from the motor driver circuit 151 is longer than the reference clock, the rotation speed of the motor 7 is increased based on the phase difference.

With this configuration, the optical disc 1 can be rotated at a constant speed. Even if slippage occurs between the optical disc 1 and the rubber roller 9, the optical disc 1 and the rotating shaft of the spindle motor 4 rotate together due to a large contact area between the optical disc 1 and the spindle 5 and pressure from the thermal head 6. Accordingly, the pulse signals output from the Hall element have the frequency accurately corresponding to the rotation speed of the optical disc 1. The rotation speed of the motor 7 is controlled utilizing this frequency, so the rotation speed of the optical disc 1 can be accurately controlled. While the rubber roller 9 is applied to the transmission means for transmitting the rotation of the motor 7 to the optical disc 1 in this embodiment, the above-described belt 110 or stepped roller 119 may alternatively applied.

While the motor driver circuit having Hall elements is used as the rotation signal generating means for generating signals corresponding to the rotation speed of the high-speed rotation spindle motor in this embodiment, a motor driver circuit having a FG detector that generates FG signals with higher rotation detection accuracy and sends the FG signals to the phase comparator 152 may alternatively be used. Other means capable of generating signals corresponding to the rotation speed of the spindle motor 4 may alternatively used. The components necessary for controlling the high-speed rotation of the optical disc 1 by the spindle motor 4 are used as the rotation signal generation means, and there is no need to newly add the rotation signal generation means for rotation speed control for low-speed rotation. Therefore, costs are not increased.

(5) Embodiment Wherein Thermal Head is Divided into Plural Parts

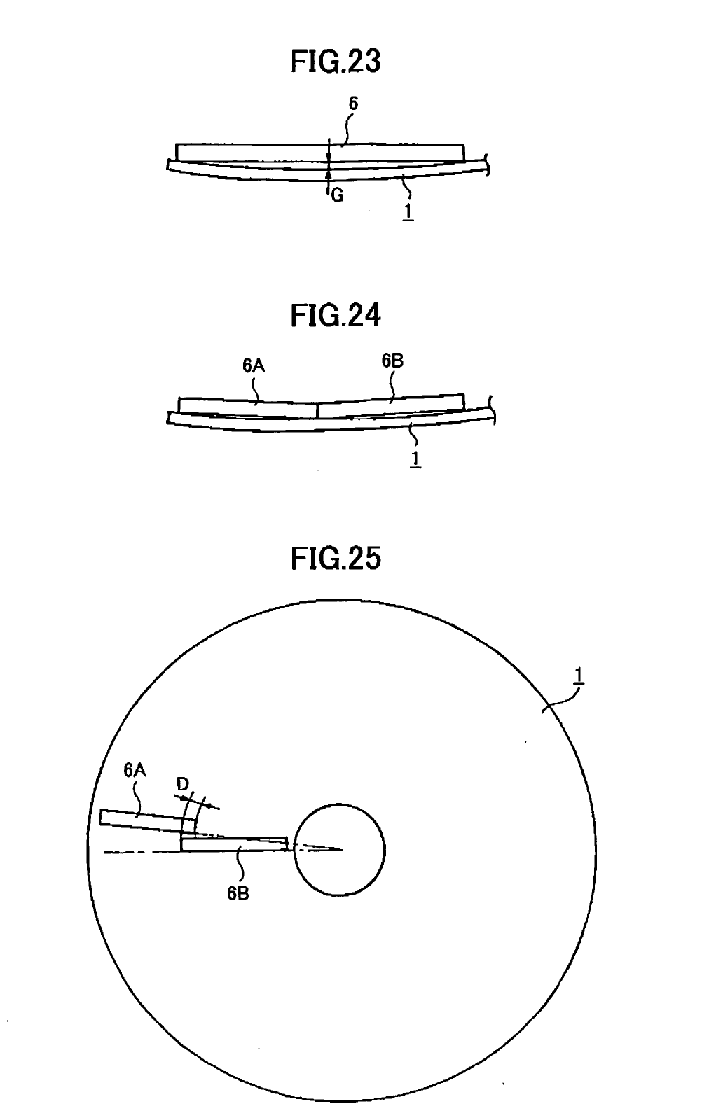

Optical discs generally have slight warpage in the radial direction. Therefore, when one thermal head 6 is urged to be in contact with the optical disc 1 throughout the radial length of the optical disc 1 in the radial direction, a clearance G (FIG. 23) might be formed. When a thermal head 6 divided into plural parts in the longitudinal direction is used, the clearance G is reduced. For example, when a thermal head 6A and a thermal head 6B are arranged in the radial direction of the optical disc 1 as shown in FIG. 24, the thermal heads 6A and 6B are slightly inclined to fit the warpage of a label-side surface of the optical disc 1 in the radial direction. Thus the clearance is reduced. With this configuration, visible information can be surely written and erased.

It is preferable that in a connected part where the thermal heads 6A and 6B abut each other, the heat generating portions of the thermal heads 6A and 6B overlap by a dot D in the radial direction of the optical disc 1. This prevents a part of the writable area from being left with the visible information unwritten.

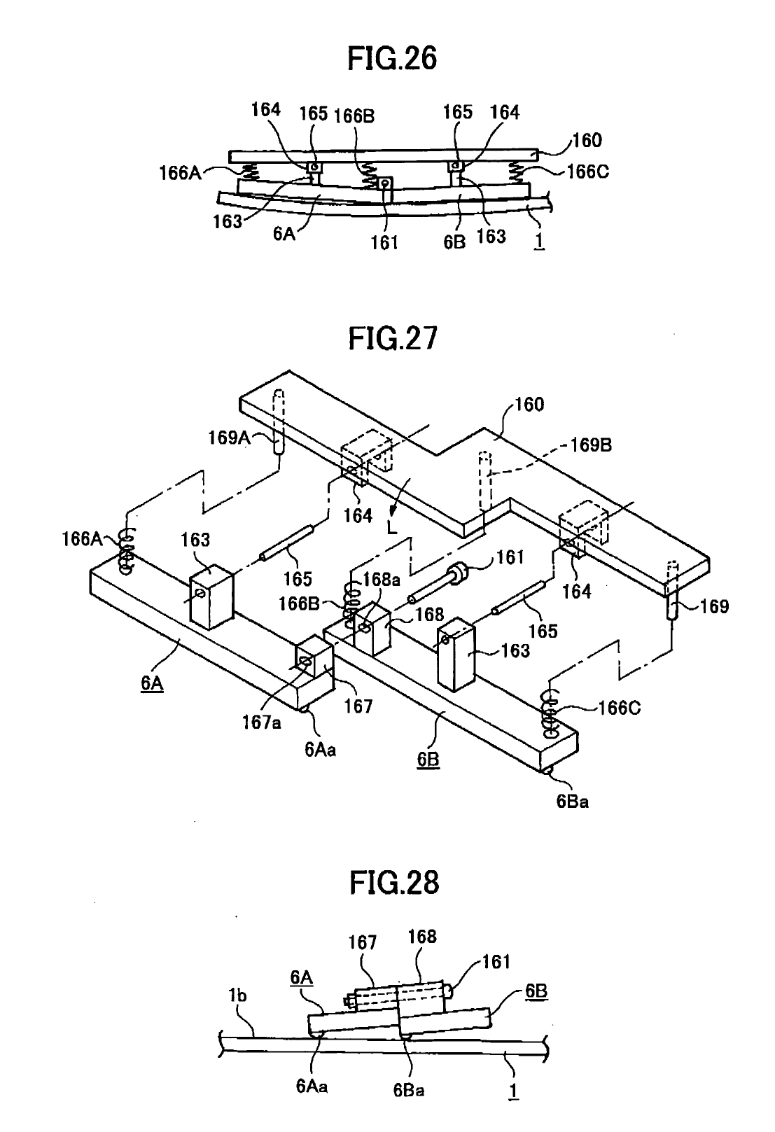

A specific embodiment having such configuration is described below. FIG. 26 is a schematic side view showing a relationship between two thermal heads 6A and 6B as illustrated in FIG. 24 and a cross section of an optical disc 1 in the radial direction. FIG. 27 is an exploded perspective view showing a thermal head unit. FIG. 28 is an illustration of the two thermal heads 6A and 6B in contact with the optical disc 1 seen from the center side of the optical disc.

In this embodiment, the partly overlapping thermal heads 6A are connected by a shaft 161 to be turnable with respect to each other.

A square column supporting portion 163 is mounted on a center part (in longitudinal direction) on an upper face of each of the thermal heads GA and 6B. Each of the upper parts of the square column supporting parts 163 is fitted in a corresponding bracket 164 attached to a lower surface of a supporting plate 160 and is connected to the bracket 164 by a corresponding pin 165. Thus the thermal heads 6A and 6B are attached to the supporting plate 160 to be turnable in the radial direction of the optical disc 1. A coil spring B is attached to a connected part of the thermal heads 6A and 6B. Coil springs A and C are attached to ends opposite to the connected part, respectively. The heat generating portions of the thermal heads 6A and 6B are thus biased to be pushed on the label-side surface of the optical disc 1. Elements indicated by reference numbers 169A-169C in FIG. 27 are guide pins of the coil springs 166A-166C, respectively.

Bearing projections 167 and 168 are disposed on the connected part of the thermal heads 6A and 6B, respectively. The bearing projection 168 of the thermal head 6B at the rear side is located slightly higher than the bearing projection 167 such that the thermal head 6B at the rear side is located lower when the thermal heads 6A and 6B are connected by the shaft 161 inserted in shaft holes 167a and 168a of the thermal heads 6A and 6B. When the supporting plate 160 is turned about a rear end thereof in a direction indicated by an arrow L to bring the thermal heads 6A and 6B into contact with a label-side surface 1b of the optical disc 1 in a state where the thermal heads 6A and 6B are slightly inclined relative to the label-side surface 1b, heat generating portions 6Aa and 6Ba of the thermal heads 6A and 6B, respectively, tightly contact the label-side surface 1b of the optical disc 1 with biasing forces of the coil springs 166A-166C.

The shaft holes 167a and 168a of the bearing projections 167 and 168 of the thermal heads 6A and GB, respectively, are slightly elongated in the longitudinal direction of the thermal heads 6A and 6B in order to absorb the displacement of a connected position due to turning movements of the thermal heads 6A and 6B.

Therefore, according to this embodiment, if the optical disc 1 has warpage in the radial direction of the optical disc 1, the thermal heads 6A and 6B are slightly inclined to fit the warpage with the biasing forces of the coil springs 166A-166C to reduce the clearance between the heat generating portions 6Aa and 6Ba and the label-side surface 1b of the optical disc 1.

In this case, the plural thermal heads 6A and 6B are attached to the supporting plate 160 to be provided as a thermal head unit.

In this embodiment, the thermal heads 6A and 6B are connected to be uneven in the width direction such that the thermal heads 6A and 6B are moved between a writing position where the heat generating portion 6Aa and 6Ba are in contact with the label-side surface 1b of the optical disc 1 and a retracted position where the heat generating portion 6Aa and 6Ba are away therefrom in a state slightly turned in the width direction together with the supporting plate 160. Alternatively, the plural thermal heads may be lifted or lowered pallralel to the label-side surface 1b of the optical disc 1 to be moved between the writing position and the retracted position. In that case, the thermal heads 6A and 6B are connected to be flush with each other.

While the thermal heads are divided in two parts in the embodiment shown in FIGS. 26-28, the thermal heads may be divided into three or more parts. If so, the thermal heads more tightly fit the warpage of the optical disc 1 to further reduce the clearance.

(6) Another Modified Embodiment of Low-Speed Rotation Mechanism

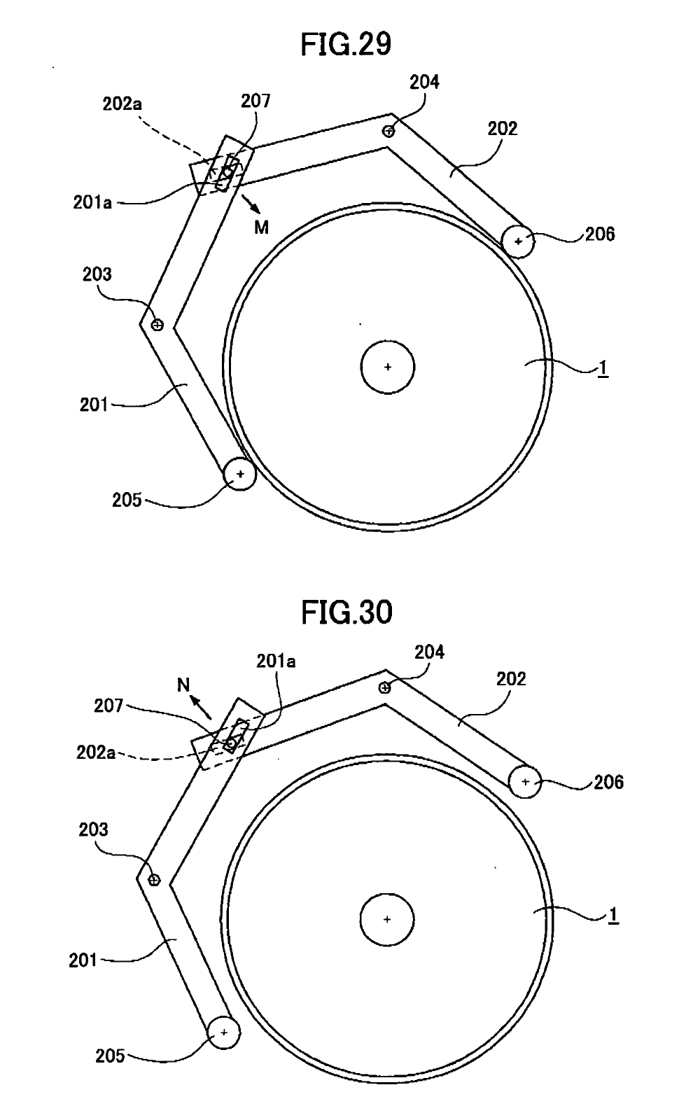

The following describes another embodiment wherein the low-speed rotation mechanism is modified. FIG. 29 is a plan view showing main parts in a state of a visible information recording operation. FIG. 30 is a plan view showing main parts in a state of a data recording operation.

In this embodiment, a pair of v-shaped levers 201 and 202 which are symmetric to each other and the open side of which facing each other are provided. A pair of rubber rollers 205 and 206 corresponding to the rubber roller 9 shown in FIGS. 1-11 are rotatably supported at a corresponding end of each of the levers 201 and 202. Bending portions of the pair of the levers 201 and 202 are rotatably supported on fixing members (not shown) by shafts 203 and 204, respectively. A pin 207 is inserted in elongated holes 201a and 202a formed on the corresponding other ends of the pair of the levers 201 and 202. In this manner, the pair of the levers 201 and 202 are connected to be turnable relative to each other.

When data are recorded on the optical disc 1, the pair of the rubber rollers 205 and 206 are positioned at retracted positions where they are away from the outer circumferential edge of the optical disc 1 as shown in FIG. 30. Operations for moving the pair of the rubber rollers 205 and 206 from the positions shown in FIG. 29 to the positions shown in FIG. 30 are as follows. The pin 207 is moved in the direction of an arrow M (FIG. 29). This movement causes the lever 201 to turn about the shaft 203 serving as a support point in the clockwise direction in FIGS. 29 and 30, and the lever 202 to turn about the shaft 204 serving as a support point in the counterclockwise direction. The rubber rollers 205 and 206 are thus moved away from the outer circumferential edge of the optical disc 1. In this state, the optical disc 1 is rotated at high speed by a spindle motor.

For the operation of recording visible information on the optical disc 1, the pin 207 is moved from the position shown in FIG. 30 in the direction of an arrow N. This movement causes the lever 201 to turn about the shaft 203 in the counterclockwise direction in FIGS. 29 and 30, and the lever 202 to turn about the shaft 204 in the clockwise direction. The rubber rollers 205 and 206 thus come into contact with the outer circumferential edge of the optical disc 1. In this state, it is preferable that a line connecting the rubber rollers 205 and 206 pass through the center Q of the optical disc 1. The pair of the rubber rollers 205 and 206 are rotated in the same direction at the same speed by a single motor through an interlocking mechanism or by different synchronized motors. Thus the optical disc 1 can be rotated in a predetermined direction at a constant speed.

According to this embodiment, since the optical disc 1 is rotated by the pair of the rubber rollers 205 and 206 disposed on both sides of the optical disc 1, the optical disc 1 can be rotated at a constant low speed more smoothly and more stably compared to the embodiment where only one rubber roller rotates the optical disc 1.

The present application is based on Japanese Priority Applications No. 2004-145599 filed on May 14, 2004, No. 2004-267296 filed on Sep. 14, 2004, and No. 2005-035034 filed on Feb. 10, 2005, with the Japanese Patent Office, the entire contents of each of which are hereby incorporated by reference.

1. An optical disc device, comprising:
a mounting section on which an optical disc serving as an information recording medium is mounted;
an optical pickup configured to irradiate a laser beam on the optical disc mounted on the mounting section so as to record and reproduce information;
a high-speed rotation mechanism configured to rotate the mounted optical disc at high speed when the optical pickup records or reproduces the information;
a thermal head that is disposed at a side opposite to the optical pickup relative to the mounted optical disc, and is configured to bring a heat generating portion into contact with a label, which is made of a thermosensitive information display film attached on a label-side surface of the mounted optical disc, to write visible information on the label; and
a low-speed rotation mechanism configured to rotate the mounted optical disc at a speed lower than said high speed when the thermal head writes the visible information on the label.

2. An optical disc device, comprising:
a mounting section on which an optical disc serving as an information recording medium is mounted;
an optical pickup configured to irradiate a laser beam on the optical disc mounted on the mounting section so as to record and reproduce information;
a high-speed rotation mechanism configured to rotate the mounted optical disc at high speed when the optical pickup records or reproduces the information;
a thermal head that is disposed at a side opposite to the optical pickup relative to the mounted optical disc, and is configured to bring a heat generating portion into contact with a label, which is made of a heat reversible information display film attached on a label-side surface of the mounted optical disc, to write and erase visible information on the label; and
a low-speed rotation mechanism configured to rotate the mounted optical disc at a speed lower than said high speed when the thermal head writes or erases the visible information on the label.

3. The optical disc device as claimed in claim 1, wherein the thermal head is arranged such that the heat generating portion extends in a radial direction of the mounted optical disc, and is able to be in contact with the label throughout a length of a radius of a writable area of the label.

4. The optical disc device as claimed in claim 2, wherein the thermal head is arranged such that the heat generating portion extends in a radial direction of the mounted optical disc, and is able to be in contact with the label throughout a length of a radius of a writable area of the label.

5. The optical disc device as claimed in claim 1, wherein the thermal head is configured to be constantly turned with a biasing force in a direction where the heat generating portion is brought into contact with the label of the mounted optical disc.

6. The optical disc device as claimed in claim 2, wherein the thermal head is configured to be constantly turned with a biasing force in a direction where the heat generating portion is brought into contact with the label of the mounted optical disc.

7. The optical disc device as claimed in claim 5, further comprising;
a rod having an eccentric portion; and
a thermal head holder engaged with the eccentric portion of the rod to be turned by rotation of the rod to a position where the thermal head is out of contact with the label against the biasing force and to a position where the thermal head is in contact with the label with the biasing force.

8. The optical disc device as claimed in claim 6, further comprising:
a rod having an eccentric portion; and
a thermal head holder engaged with the eccentric portion of the rod to be turned by rotation of the rod to a position where the thermal head is out of contact with the label against the biasing force and to a position where the thermal head is in contact with the label with the biasing force.

9. The optical disc device as claimed in claim 1, further comprising:
a supporting member configured to move into sliding contact with an outer circumferential edge of the rotating optical disc to support the optical disc against a contact force of the thermal head as the thermal head is brought into contact with the label of the optical disc.

10. The optical disc device as claimed in claim 2, further comprising:
a supporting member configured to move into sliding contact with an outer circumferential edge of the rotating optical disc to support the optical disc against a contact force of the thermal head as the thermal head is brought into contact with the label of the optical disc.

11. The optical disc device as claimed in claim 1, wherein the low-speed rotation mechanism comprises:
a roller capable of moving into and out of contact with an outer circumferential edge of the mounted optical disc; and
a motor to rotate the roller; wherein
when the roller moves into contact with the outer circumferential edge of the optical disc and is rotated, the optical disc is rotated at a low speed by the roller.

12. The optical disc device as claimed in claim 2, wherein the low-speed rotation mechanism comprises;
a roller capable of moving into and out of contact with an outer circumferential edge of the mounted optical disc; and
a motor to rotate the roller; wherein
when the roller moves into contact with the outer circumferential edge of the optical disc and is rotated, the optical disc is rotated at a low speed by the roller.

13. The optical disc device as claimed in claim 11, further comprising:
an interlocking mechanism to interlock movements of the roller of the low-speed rotation mechanism toward and away from the mounted optical disc and movements of the thermal head toward and away from the label of the optical disc with a drive force of a drive source.

14. The optical disc device as claimed in claim 12, further comprising:
an interlocking mechanism to interlock movements of the roller of the low-speed rotation mechanism toward and away from the mounted optical disc and movements of the thermal head toward and away from the label of the optical disc with a drive force of a drive source.

15. The optical disc device as claimed in claim 11, wherein the roller includes a rubber roller.

16. The optical disc device as claimed in claim 12, wherein the roller includes a rubber roller.

17. The optical disc device as claimed in claim 9, wherein the low-speed rotation mechanism comprises:
a roller capable of moving into and out of contact with an outer circumferential edge of the mounted optical disc; and
a motor to rotate the roller; wherein
when the roller moves into contact with the outer circumferential edge of the optical disc and is rotated, the optical disc is rotated at a low speed by the roller.

18. The optical disc device as claimed in claim 10, wherein the low-speed rotation mechanism comprises:
a roller capable of moving into and out of contact with an outer circumferential edge of the mounted optical disc; and
a motor to rotate the roller; wherein
when the roller moves into contact with the outer circumferential edge of the optical disc and is rotated, the optical disc is rotated at a low speed by the roller.

19. The optical disc device as claimed in claim 17, further comprising:
an interlocking mechanism to interlock movements of the roller of the low-speed rotation mechanism toward and away from the mounted optical disc, movements of the thermal head toward and away from the label of the optical disc, and movements of the supporting member toward and away from the outer circumferential edge of the optical disc with a drive force of a drive source.

20. The optical disc device as claimed in claim 18, further comprising:
an interlocking mechanism to interlock movements of the roller of the low-speed rotation mechanism toward and away from the mounted optical disc, movements of the thermal head toward and away from the label of the optical disc, and movements of the supporting member toward and away from the outer circumferential edge of the optical disc with a drive force of a drive source.

21. The optical disc device as claimed in claim 19, wherein the roller includes a rubber roller.

22. The optical disc device as claimed in claim 20, wherein the roller includes a rubber roller.

23. The optical disc device as claimed in claim 13, wherein the low-speed rotation mechanism, the thermal head, and the interlocking mechanism are held by a holder to form a visible information writing unit.

24. The optical disc device as claimed in claim 14, wherein the low-speed rotation mechanism, the thermal head, and the interlocking mechanism are held by a holder to form a visible information writing unit.

25. The optical disc device as claimed in claim 19, wherein the low-speed rotation mechanism, the thermal head, the supporting member, and the interlocking mechanism are held by a holder to form a visible information writing unit.

26. The optical disc device as claimed in claim 20, wherein the low-speed rotation mechanism, the thermal head, the supporting member, and the interlocking mechanism are held by a holder to form a visible information writing unit.

27. The optical disc device as claimed in claim 1, wherein the low-speed rotation mechanism comprises:
a pair of rollers or pulleys around which a belt is extended to allow the belt to move into and out of contact with an outer circumferential edge of the mounted optical disc; and
a motor to rotate the belt; wherein
when the belt moves into contact with the outer circumferential edge of the optical disc and is rotated, the optical disc is rotated at a low speed by the belt.

28. The optical disc device as claimed in claim 2, wherein the low-speed rotation mechanism comprises:
a pair of rollers or pulleys around which a belt is extended to allow the belt to move into and out of contact with an outer circumferential edge of the mounted optical disc; and
a motor to rotate the belt; wherein
when the belt moves into contact with the outer circumferential edge of the optical disc and is rotated, the optical disc is rotated at a low speed by the belt.

29. The optical disc device as claimed in claim 1, wherein the low-speed rotation mechanism comprises:
a low-speed rotation motor; and
a transmission section to transmit a drive force of the motor to the mounted optical disc so as to rotate the optical disc at a low speed; wherein
the transmission section serves as a supporting member that supports the optical disc slidably against a contact force of the thermal head.

30. The optical disc device as claimed in claim 2, wherein the low-speed rotation mechanism comprises:
a low-speed rotation motor; and
a transmission section to transmit a drive force of the motor to the mounted optical disc so as to rotate the optical disc at a low speed; wherein
the transmission section serves as a supporting member that supports the optical disc slidably against a contact force of the thermal head.

31. The optical disc device as claimed in claim 29, wherein the transmission section comprises:
a stepped roller having a large diameter portion and a small diameter portion formed integrally on the large diameter portion; wherein
the stepped roller is driven by the low-speed rotation motor;
an outer circumferential edge of the small diameter portion moves into contact with the outer circumferential edge of the optical disc to rotate the optical disc at a low speed; and
an upper face of the large diameter portion supports a face of the optical disc opposite to a face with which the thermal head moves into contact.

32. The optical disc device as claimed in claim 30, wherein the transmission section comprises:
a stepped roller having a large diameter portion and a small diameter portion formed integrally on the large diameter portion; wherein
the stepped roller is driven by the low-speed rotation motor;
an outer circumferential edge of the small diameter portion moves into contact with the outer circumferential edge of the optical disc to rotate the optical disc at a low speed; and
an upper face of the large diameter portion supports a face of the optical disc opposite to a face with which the thermal head moves into contact.

33. The optical disc device as claimed in claim 29, wherein the transmission section comprises;
a stepped roller having a large diameter portion and a small diameter portion formed integrally on the large diameter portion; and
a belt extending around an outer circumferential edge of the small diameter portion of the stepped roller and a second roller or a pulley; wherein
the stepped roller is driven by the low-speed rotation motor;
the belt moves into contact with the outer circumferential edge of the optical disc to rotate the optical disc at a low speed; and
an upper face of the large diameter portion of the stepped roller supports a face of the optical disc opposite to a face with which the thermal head moves into contact.

34. The optical disc device as claimed in claim 30, wherein the transmission section comprises:
a stepped roller having a large diameter portion and a small diameter portion formed integrally on the large diameter portion; and
a belt extending around an outer circumferential edge of the small diameter portion of the stepped roller and a second roller or a pulley; wherein
the stepped roller is driven by the low-speed rotation motor;
the belt moves into contact with the outer circumferential edge of the optical disc to rotate the optical disc at a low speed; and
an upper face of the large diameter portion of the stepped roller supports a face of the optical disc opposite to a face with which the thermal head moves into contact.

35. The optical disc device as claimed in claim 33,
wherein the second roller or the pulley includes a stepped roller having a large diameter portion and a small diameter portion formed integrally on the large diameter portion;
a part of the belt extending between the small diameter portions of the two stepped rollers moves into contact with the outer circumferential edge of the optical disc to rotate the optical disc at a low speed; and
an upper face of the large diameter portion of each of the stepped rollers supports a face of the optical disc opposite to a face with which the thermal head moves into contact.

36. The optical disc device as claimed in claim 34,
wherein the second roller or the pulley includes a stepped roller having a large diameter portion and a small diameter portion formed integrally on the large diameter portion;
a part of the belt extending between the small diameter portions of the two stepped rollers moves into contact with the outer circumferential edge of the optical disc to rotate the optical disc at a low speed; and
an upper face of the large diameter portion of each of the stepped rollers supports a face of the optical disc opposite to a face with which the thermal head moves into contact.

37. The optical disc device as claimed 15 in claim 31, wherein the upper face of the large diameter portion of the stepped roller has an upwardly bulging annular surface.

38. The optical disc device as claimed in claim 32, wherein the upper face of the large diameter portion of the stepped roller has an upwardly bulging annular surface.

39. The optical disc device as claimed in claim 33, wherein the upper surface of the large diameter portion of the stepped roller has an upwardly bulging annular surface.

40. The optical disc device as claimed in claim 34, wherein the upper surface of the large diameter portion of the stepped roller has an upwardly bulging annular surface.

41. The optical disc device as claimed in claim 27, wherein the belt includes a rubber belt.

42. The optical disc device as claimed in claim 28, wherein the belt includes a rubber belt.

43. The optical disc device as claimed in claim 33, wherein the belt includes a rubber belt.

44. The optical disc device as claimed in claim 34, wherein the belt includes a rubber belt.

45. The optical disc device as claimed in claim 27, wherein the belt includes a timing belt.

46. The optical disc device as claimed in claim 28, wherein the belt includes a timing belt.

47. The optical disc device as claimed in claim 33, wherein the belt includes a timing belt.

48. The optical disc device as claimed in claim 34, wherein the belt includes a timing belt.

49. The optical disc device as claimed in claim 1, further comprising:
a ball-shaped rolling support to support a face of the mounted optical disc opposite to a face with which the thermal head moves into contact.

50. The optical disc device as claimed in claim 2, further comprising:
a ball-shaped rolling support to support a face of the mounted optical disc opposite to a face with which the thermal head moves into contact.

51. The optical disc device as claimed in claim 49, wherein the ball-shaped rolling support is disposed at a position opposing the thermal head through the optical disc.

52. The optical disc device as claimed in claim 50, wherein the ball-shaped rolling support is disposed at a position opposing the thermal head through the optical disc.

53. The optical disc device as claimed in claim 49,
wherein at least two of the ball-shaped rolling supports are provided; and
the at least two of the ball-shaped rolling supports are disposed at opposite sides of a position of the thermal head in a radial direction of the optical disc within an angular spacing of 180 degrees or less at a side of the optical disc opposing the thermal head through the optical disc.

54. The optical disc device as claimed in claim 50,
wherein at least two of the ball-shaped rolling supports are provided; and
the at least two of the ball-shaped rolling supports are disposed at opposite sides of a position of the thermal head in a radial direction of the optical disc within an angular spacing of 180 degrees or less at a side of the optical disc opposing the thermal head through the optical disc.

55. The optical disc device as claimed in claim 53, wherein the at least two of the ball-shaped rolling supports are disposed within an angular spacing of 90 degrees or less.

56. The optical disc device as claimed in claim 54, wherein the at least two of the ball-shaped rolling supports are disposed within an angular spacing of 90 degrees or less.

57. The optical disc device as claimed in claim 53, wherein the at least two of the ball-shaped rolling supports are disposed at positions symmetrical relative to the position of the thermal head in the radial direction of the optical disc.

58. The optical disc device as claimed in claim 54, wherein the at least two of the ball-shaped rolling supports are disposed at positions symmetrical relative to the position of the thermal head in the radial direction of the optical disc.

59. The optical disc device as claimed in claim 1,
wherein the high-speed rotation mechanism includes
a high-speed rotation motor configured to be rotated by rotation of the optical disc when the high-speed rotation motor is not driven; and
a rotation signal generating section to generate signals corresponding to a rotation speed of the high-speed rotation motor; and
the low-speed rotation mechanism includes
a low-speed rotation motor;
the optical disc device further comprising:
a disc rotation control section configured to control rotation of the low-speed rotation motor according to the signals generated by the rotation signal generating section so as to rotate the optical disc at a predetermined speed, when the low-speed rotation motor is driven to cause the low-speed rotation mechanism to rotate the mounted optical disc at a low speed and the high-speed rotation motor is rotated by rotation of the optical disc.

60. The optical disc device as claimed in claim 2,
wherein the high-speed rotation mechanism includes
a high-speed rotation motor configured to be rotated by rotation of the optical disc when the high-speed rotation motor is not driven; and
a rotation signal generating section to generate signals corresponding to a rotation speed of the high-speed rotation motor; and
the low-speed rotation mechanism includes
a low-speed rotation motor;
the optical disc device further comprising:
a disc rotation control section configured to control rotation of the low-speed rotation motor according to the signals generated by the rotation signal generating section so as to rotate the optical disc at a predetermined speed, when the low-speed rotation motor is driven to cause the low-speed rotation mechanism to rotate the mounted optical disc at a low speed and the high-speed rotation motor is rotated by rotation of the optical disc.

61. The optical disc device as claimed in claim 59,
wherein the rotation signal generating section generates FG signals corresponding to a rotation speed of the high-speed rotation motor; and
the disc rotation control section is configured to control the rotation of the low-speed rotation motor according to the FG signals.

62. The optical disc device as claimed in claim 60,
wherein the rotation signal generating section generates FG signals corresponding to a rotation speed of the high-speed rotation motor; and
the disc rotation control section is configured to control the rotation of the low-speed rotation motor according to the FG signals.

63. The optical disc device as claimed in claim ¹, wherein the thermal head comprises:
a plurality of thermal heads arranged along a radial direction of the mounted optical disc.

64. The optical disc device as claimed in claim 2, wherein the thermal head comprises:
a plurality of thermal heads arranged along a radial direction of the mounted optical disc.

65. The optical disc device as claimed in claim 63, wherein the heat generating portions of the thermal heads overlap in the radial direction of the optical disc in a connected part where the thermal heads abut each other.

66. The optical disc device as claimed in claim 64, wherein the heat generating portions of the thermal heads overlap in the radial direction of the optical disc in a connected part where the thermal heads abut each other.
